(19) United States
(12) Patent Application Publication
(10) Pub. No.: US 2022/0250435 A1
(43) Pub. Date: Aug. 11, 2022

(54) VEHICLE AIR CONDITIONERS

(71) Applicant: Mahle International GmbH, Stuttgart (DE)

(72) Inventors: Shingo Wakamatsu, Tochigi (JP); Yoji Katsuki, Tochigi (JP); Hirokazu Endo, Tochigi (JP); Naoki Yanagita, Tochigi (JP); Yasunobu Muraoka, Tochigi (JP); Akira Hosoya, Tochigi (JP); Koichi Kaiyama, Tochigi (JP)

(21) Appl. No.: 17/586,762

(22) Filed: Jan. 27, 2022

(30) Foreign Application Priority Data
Jan. 28, 2021 (JP) 2021-012390

(51) Int. Cl. B60H 1/00

(52) U.S. Cl. CPC B60H 1/00564; B60H 1/00021; B60H 1/00671

(57) ABSTRACT

A vehicle air conditioning device is disclosed. The air condition device includes an air conditioning case having a passage in which air flows, a blower connected to the air conditioning case for blowing the air, a cooler and a heater housed in an interior of the air conditioning case, and a duct provided in the air conditioning case for conveying the air that has been temperature controlled by the cooler and the heater. The passage includes a cool air passage in which the cooler is disposed, a warm air passage in which the heater is disposed, and an introduction passage provided between the cool air passage and the warm air. A switching door is provided in the introduction passage for controlling an amount of the air flowing to the cool air passage and the warm air passage.

### CROSS-REFERENCE TO RELATED APPLICATION

This application claims priority to Japanese Application No. JP 2021-012390 filed Jan. 28, 2021, the contents of which are hereby incorporated by reference in its entirety.

### TECHNICAL FIELD

The present invention relates to a vehicle air conditioning device for blowing air into a vehicle interior, the air having been temperature controlled, to control temperature in the vehicle interior.

### BACKGROUND

A vehicle air conditioning device mounted in a vehicle is provided with a blower, an evaporator, and a heater core as disclosed in JP 592285. The blower takes in air from the exterior into an air conditioning case. The evaporator and the heater core are disposed inside the air conditioning case. The evaporator cools air. The heater core is disposed downstream of the evaporator. The heater core heats the air.

The blower is driven such that air from the exterior of the air conditioning case into the inside of the air conditioning case. After this air is cooled and dehumidified by the evaporator, the ratio between air passing through the heater core and air that bypasses the heater core is controlled by an air mix damper. As a result, the temperature of the blown air blown from the vehicle air conditioning device into the vehicle interior is controlled.

### SUMMARY

In the vehicle air conditioning device described above, all of the air taken into the air conditioning case from the blower passes through the evaporator. Therefore, during the heating operation for heating air and blowing the air into the vehicle interior, air that has been taken into the air conditioning case passes through the evaporator and flows to the heater core to be heated. Even when performing the heating operation for heating the air, the air temporarily passes through the evaporator, thereby increasing the ventilation resistance of the air. The air blowing capability of the vehicle air conditioning device decreases as the ventilation resistance of the air increases.

A general object of the present invention is to provide a vehicle air conditioning device that can improve blowing efficiency by reducing ventilation resistance of air flowing in an air conditioning case.

To achieve the above object, an aspect of the present invention is a vehicle air conditioning device, provided with: an air conditioning case having a passage in which air flows; a blower connected to the air conditioning case for blowing the air; a cooler and a heater housed in the interior of the air conditioning case; and a duct provided in the air conditioning case for blowing the air that has been temperature controlled by the cooler and the heater; wherein:

the passage in the air conditioning case is provided with a cool air passage in which the cooler is disposed; a warm air passage in which the heater is disposed; and an introduction passage provided between the cool air passage and the warm air passage for communicating upstream from the cool air passage and the warm air passage, to which air is introduced from the blower; and
air in the introduction passage branches to the cool air passage and the warm air passage, and a switching door is provided in the introduction passage for controlling the amount of the air flowing to the cool air passage and the warm air passage.

According to the present invention, by providing an introduction passage in the air conditioning case, the introduction passage being provided between the cool air passage and the warm air passage and communicating upstream from the cool air passage and the warm air passage, air being introduced into the introduction passage from the blower via the air intake, by branching air introduced into the introduction passage to the cool air passage and the warm air passage, and by providing a switching door in the introduction passage, the switching door being able to control the amount of air flowing from the introduction passage to the cool air passage and the warm air passage, air introduced into the introduction passage can be blown to a desired side of either the cooler side or the heater side under the switching operation of the switching door, and for example, when air does not need to undergo heat exchange by the cooler, ventilation resistance does not occur when air passes through the cooler.

As a result, blowing efficiency can be improved in the vehicle air conditioning device by reducing ventilation resistance of air flowing in the air conditioning case.

The object, characteristics, and advantages described above will be easily understood from the description of the embodiments described below with reference to attached drawings.

### BRIEF DESCRIPTION OF THE DRAWINGS

FIG. 1 is an overall plan configuration view viewing the vehicle air conditioning device relating to the first embodiment of the present invention from the top.

FIG. 2 is an overall side configuration view viewing the vehicle air conditioning device in FIG. 1 from the side.

FIG. 3 is an overall plan configuration view illustrating a state wherein the vehicle air conditioning device in FIG. 1 is performing a cooling operation.

FIG. 4 is an overall front configuration view of the vehicle air conditioning device relating to the second embodiment of the present invention.

FIG. 5 is an overall side configuration view viewing the vehicle air conditioning device in FIG. 4 from the side.

FIG. 6 is an overall plan configuration view viewing the vehicle air conditioning device relating to the third embodiment of the present invention from the top.

FIG. 7 is a cross-sectional view along the VII-VII line in FIG. 6.

FIG. 8 is an overall side configuration view viewing the vehicle air conditioning device illustrated in FIG. 6 from the side.

FIG. 9 is an exploded perspective view of the vehicle air conditioning device illustrated in FIG. 8.

FIG. 10 is an overall plan configuration view illustrating a vehicle air conditioning device when operated in a foot mode.

FIG. 11 is a cross-sectional view along the XI-XI line in FIG. 10.

FIG. 12 is an overall plan configuration view illustrating a vehicle air conditioning device when operated in a defroster mode.

FIG. 13 is a cross-sectional view along the XII-XII line in FIG. 12.

FIG. 14 is an overall cross-sectional view illustrating the vehicle air conditioning device according to a first variation.

FIG. 15A is an overall cross-sectional view of the vehicle air conditioning device according to a second variation, and FIG. 15B is an overall cross-sectional view when the vehicle air conditioning device in FIG. 15A is operated in a face mode.

FIG. 16 is an overall cross-sectional view illustrating the vehicle air conditioning device according to a third variation.

FIG. 17 is an overall plan configuration view viewing the vehicle air conditioning device relating to the fourth embodiment of the present invention from the top.

FIG. 18 is an overall plan configuration view of when the vehicle air conditioning device in FIG. 17 is operated in a bi-level mode.

FIG. 19 is an overall plan configuration view viewing the vehicle air conditioning device relating to the fifth embodiment of the present invention from the top.

FIG. 20 is an overall plan configuration view of when the vehicle air conditioning device in FIG. 19 is operated in a bi-level mode.

### DETAILED DESCRIPTION

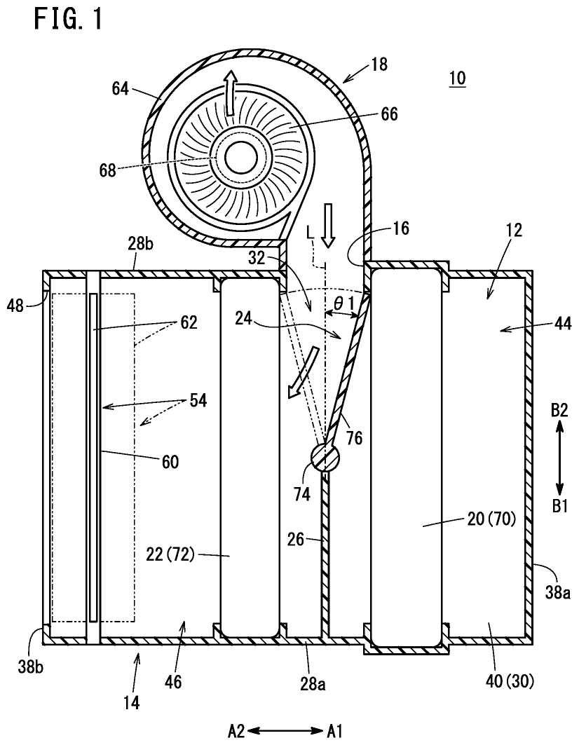

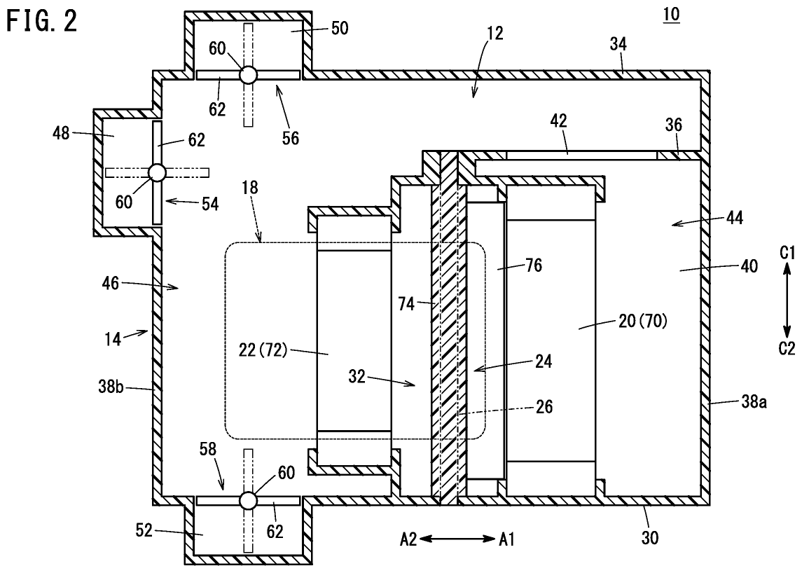

As illustrated in FIG. 1 and FIG. 2, a vehicle air conditioning device 10 according to the first embodiment includes an air conditioning case 14 having a passage 12 in the interior thereof, a blower 18 connected to an air intake 16 of the air conditioning case 14, an evaporator (cooler) 20 and a heater core (heater) 22 housed in the interior of the air conditioning case 14, and a switching door 24 provided between the evaporator 20 and the heater core 22.

For example, the air conditioning case 14 is formed in a substantial square shape when viewed from above as illustrated in FIG. 1, and in the interior thereof, the switching door 24 and a partition wall (partition plate) 26 are provided substantially in the center along the width direction (direction of arrows A1 and A2), and the evaporator 20 and the heater core 22 are disposed substantially parallel separated a prescribed distance to be separated in the width direction (direction of arrows A1 and A2) interposing the switching door 24 and the partition wall 26. That is, this vehicle air conditioning device 10 has a horizontal structure wherein the evaporator 20 and the heater core 22 are disposed in parallel in the width direction (horizontal direction, direction of arrows A1 and A2) in the air conditioning case 14.

In the interior of the air conditioning case 14, the partition wall 26 extends in a straight line from a side wall 28a on one side in the depth direction (direction of arrow B1 in FIG. 1) of the air conditioning case 14 orthogonal to the width direction toward the other side in the depth direction to the substantial central portion thereof, and as illustrated in FIG. 2, is formed at a prescribed height rising (direction of arrow C1) from a bottom wall 30 of the air conditioning case 14 to reach the evaporator 20 and the heater core 22.

Furthermore, as illustrated in FIG. 1, the air intake 16 opens on a side wall 28b on the other side in the depth direction (direction of arrow B2) in the air conditioning case 14, and this air intake 16 opens to reach the switching door 24 and the partition wall 26 substantially in the center in the width direction of the air conditioning case 14, and communicates to an introduction space (introduction passage) 32 provided in the air conditioning case 14. A blower 18 described hereinafter is connected to the air intake 16 on the side wall 28b of the air conditioning case 14.

Additionally, when viewed from the side illustrated in FIG. 2, the air conditioning case 14 has the bottom wall 30 formed below (direction of arrow C2) and a ceiling wall 34 formed above (direction of arrow C1) substantially parallel with the bottom wall 30, and a separating wall 36 is formed between the bottom wall 30 and the ceiling wall 34 to cover the top of the evaporator 20. The separating wall 36 is formed to be substantially parallel to the bottom wall 30 and the ceiling wall 34, extends from the substantial center in the width direction to the side wall 38a on one side (direction of arrow A1) in the width direction, a housing chamber 40 for housing the evaporator 20 is formed below this, and a communication hole 42 is made for the housing chamber 40 and a portion on the top of the passage to communicate.

As illustrated in FIG. 2, in the interior of the air conditioning case 14, the space between the housing chamber 40 housing the evaporator 20, the communication hole 42, and the passage portion between the ceiling wall 34 and the separating wall 36 creates a cool air passage 44 in which air cooled by the evaporator 20 (cool air) flows, while a warm air passage 46 in which the heater core 22 is disposed extends from the site where the heater core 22 is disposed to the other side in the width direction (direction of arrow A2). The cool air passage 44 and the warm air passage 46 are separated in the width direction (direction of arrows A1 and A2) by the partition wall 26 provided substantially in the center of the air conditioning case 14 in the width direction (see FIG. 1).

Moreover, as illustrated in FIG. 1 and FIG. 2, the air conditioning case 14 is provided with a vent duct 48 made in the side wall 38b on the other side in the width direction (direction of arrow A2), a defroster duct 50 made in the ceiling wall 34 in the vicinity of the vent duct 48, and a heat duct 52 made in the bottom wall 30 in the vicinity of the vent duct 48. The vent duct 48, the defroster duct 50, and the heat duct 52 are all disposed on the other side in the width direction (direction of arrow A2) on the side of the heater core 22 in the air conditioning case 14.

In the vent duct 48, a vent door 54 for controlling the state of blown air in the vicinity of the face of a occupant in the vehicle interior is provided to be able to open and close, in the defroster duct 50, a defroster door 56 for switching the state of blown air to the front window of the vehicle is provided to be able to open and close, and in the heat duct 52, a heat door 58 for controlling the state of blown air in the vicinity of the feet of a occupant in the vehicle interior is provided to be able to open and close.

The vent door 54, the defroster door 56, and the heat door 58 are butterfly doors having a shaft 60 rotatably supported with respect to the air conditioning case 14, and a pair of plate-shaped door portions 62 extending to both sides in the radial direction with respect to the shaft 60, and are provided to be able to open and close each duct by rotating around the center of the shaft 60.

The blower 18 includes, for example, a fan case 64 provided to reach the side wall 28b of the air conditioning case 14, having a coiled passage portion, a fan 66 rotatably housed in the fan case 64, and a motor 68 for rotating the fan 66, and the downstream end of the fan case 64 is connected to the air intake 16 of the air conditioning case 14. The motor 68 is driven when energized and operated to rotate the fan 66, and the blower 18 thereby introduces air introduced into the passage portion of the fan case 64 from the air intake 16 to the interior of the air conditioning case 14.

For example, the evaporator 20 is disposed to be separated a prescribed distance on one side in the width direction (direction of arrow A1) from the switching door 24 and the partition wall 26 disposed substantially in the center in the width direction in the interior of the air conditioning case 14, is disposed to run along the depth direction (direction of arrows B1 and B2), and is fixed to the air conditioning case 14. The evaporator 20 has a first heat exchange portion 70 formed such that a refrigerant (first heat exchange medium) can be circulated therein and air flowing in the passage 12 in the air conditioning case 14 can pass through. The evaporator 20 cools the air by exchanging heat between the air passing through the first heat exchange portion 70 and the refrigerant circulating therein, and supplies the cool air to the downstream side.

For example, the heater core 22 is disposed to be separated a prescribed distance on the other side in the width direction (direction of arrow A2) from the switching door 24 and the partition wall 26 disposed substantially in the center in the width direction in the interior of the air conditioning case 14, is disposed to run along the depth direction (direction of arrows B1 and B2), and is fixed to the air conditioning case 14.

Moreover, the heater core 22 has a second heat exchange portion 72 that is connected to a cooling water circuit in the internal combustion engine in a vehicle not illustrated in the drawings via piping not illustrated in the drawings, formed such that heated cooling water (warm water, second heat exchange medium) circulates therein, and in which air flowing in the passage 12 in the air conditioning case 14 can pass through. The heater core 22 heats the air by exchanging heat between the air passing through the second heat exchange portion 72 and the warm water circulating therein, and supplies the warm air to the downstream side.

That is, the evaporator 20 and the heater core 22 are disposed substantially parallel so as to be separated in the width direction (direction of arrows A1 and A2) a prescribed distance interposing the switching door 24 and the partition wall 26. Specifically, the first heat exchange portion 70 of the evaporator 20 and the second heat exchange portion 72 of the heater core 22 are disposed to face each other interposing the partition wall 26 separating the cool air passage 44 and the warm air passage 46.

The switching door 24 has a cantilever structure having a rotating shaft 74 and a plate-shaped shielding portion (shielding plate) 76 extending to the outside in the radial direction with respect to the rotating shaft 74, as illustrated in FIG. 2, and the rotational shaft 74 extends in the vertical direction (direction of arrows C1 and C2) of the air conditioning case 14 and is rotationally held respectively by the bottom wall 30 and the separating wall 36m, is disposed to be parallel to the evaporator 20 and the heater core 22 between the evaporator 20 and the heater core 22, and is provided to be adjacent to the other end in the depth direction of the partition wall 26 (see FIG. 1).

The shielding portion 76 is disposed on the other side in the depth direction (direction of arrow B2) with respect to the rotating shaft 74 in the air conditioning case 14, and by rotating the rotating shaft 74, rotation occurs at a prescribed angle from a position reaching the evaporator 20 to a position reaching the heater core 22 in the introduction space 32 provided between the evaporator 20 and the heater core 22.

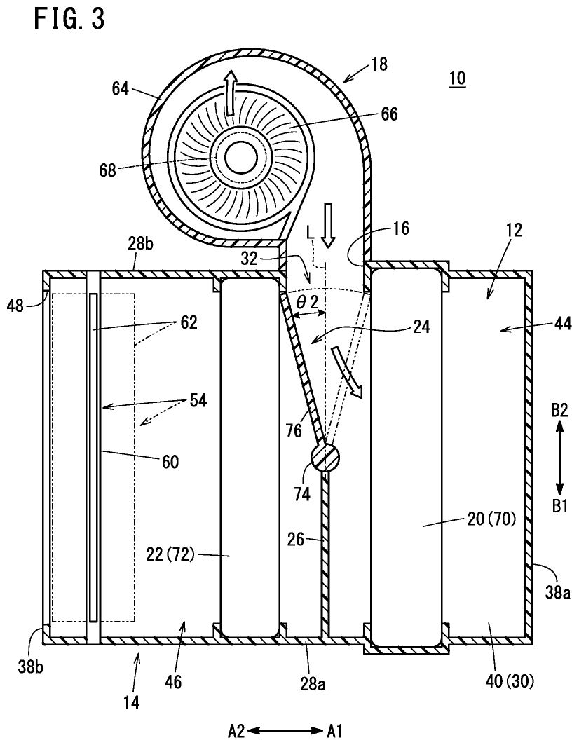

Moreover, for example, in the introduction space 32, the shielding portion 76 is formed such that a rotation angle θ1 (rotation amount) to one side in the width direction (direction of arrow A1) on the side of the evaporator 20 illustrated in FIG. 1 and a rotation angle θ2 (rotation amount) to the other side in the width direction (direction of arrow A2) on the side of the heater core 22 illustrated in FIG. 3 are the same (θ1=θ2) with respect to a virtual line L extending the rotating shaft 74 and the partition wall 26 in the depth direction (direction of arrows B1 and B2).

In the switching door 24, the rotating shaft 74 rotates under the driving operation of driving means for driving based on a control signal from a controller not illustrated in the drawings, and by the shielding portion 76 rotating in a prescribed direction in the introduction space 32 in accordance with said rotation, the flow state and flow amount of air introduced into the introduction space 32 can be controlled (switched) to the one side in the width direction (direction of arrow A1) and the other side in the width direction (direction of arrow A2).

The vehicle air conditioning device 10 according to the first embodiment of the present invention has the basic configuration described above, and the operation and action effect thereof will be described below.

First, a description will be given of when a heating operation is performed for blowing warm air to the vicinity of the feet of an occupant illustrated in FIG. 1. In this case, the driving means is driven based on a control signal from a controller not illustrated in the drawings, and as illustrated in FIG. 1, the switching door 24 is rotated clockwise around the rotating shaft 74 creating a state wherein the introduction space 32 and the heater core 22 communicate, and the heat door 58 is rotated to create a state wherein the heat duct 52 is open. Meanwhile, the vent duct 48 and the defroster duct 50 are closed by the vent door 54 and the defroster door 56, respectively.

By driving the motor 68 when the blower 18 is energized and operated to rotate the fan 66, air taken into the passage portion of the fan case 64 is introduced into the introduction space 32 of the air conditioning case 14 via the air intake 16, and air flows to the heater core 22 side (in FIG. 1, the other side in the width direction, the direction of arrow A2) opened by the rotation of the switching door 24. Note that in the introduction space 32, air does not flow from the introduction space 32 to the evaporator 20 side because the evaporator 20 side (one side in the width direction, direction of arrow A1) is closed by the switching door 24.

Air in the introduction space 32 passes through the heater core 22 and therefore undergoes a heat exchange with the warm water circulating in the second heat exchange portion 72 and is heated to become warm air, and this warm air flows to the other side in the width direction (direction of arrow A2) from the downstream side of the heater core 22 in the warm air passage 46 and is blown from the open heat duct 52 to the vicinity of the feet of an occupant in the vehicle interior.

Next, a description will be given of when a cooling operation is performed for blowing cool air to the vicinity of the face of an occupant illustrated in FIG. 3. In this case, the driving means is driven based on a control signal from a controller not illustrated in the drawings, and the switching door 24 is rotated counter-clockwise around the rotating shaft 74 creating a state wherein the introduction space 32 and the evaporator 20 communicate, and the vent door 54 is rotated to create a state wherein the vent duct 48 is open. Meanwhile, the defroster duct 50 and the heat duct 52 are closed by the defroster door 56 and the heat door 58, respectively.

Air taken into the fan case 64 under the driving operation of the blower 18 is introduced into the introduction space 32 of the air conditioning case 14 via the air intake 16, and air flows to the evaporator 20 side (one side in the width direction, the direction of arrow A1) opened by the rotation of the switching door 24. Note that in the introduction space 32, air does not flow from the introduction space 32 to the heater core 22 side because the heater core 22 side (other side in the width direction, direction of arrow A2) is closed by the switching door 24.

By air in the introduction space 32 passing through the evaporator 20, the air undergoes a heat exchange with the refrigerant circulating in the first heat exchange portion 70 and is cooled and becomes cool air, after this cool air flows into the housing chamber 40 on the one side in the width direction (direction of arrow A1) in the air conditioning case 14 that will be the downstream side of the evaporator 20, the cool air flows to the ceiling wall 34 side via the communication hole 42 of the separating wall 36 configuring the cool air passage 44, and flows to other side in the width direction (direction of arrow A2) along the ceiling wall 34 and is thereby blown from the opened vent duct 48 to the vicinity of the face of an occupant in the vehicle interior.

That is, during the cooling operation of the vehicle air conditioning device 10, as illustrated in FIG. 2, the flow of air flowing from the introduction space 32 to the evaporator 20 temporarily flows to the one side in the width direction (direction of arrow A1) and is lifted, and then reverses and flows to the other side in the width direction (direction of arrow A2). In other words, in the vehicle air conditioning device 10, the passage length of the cool air passage 44 in which the cool air flows is formed to be longer than the passage length of the warm air passage 46 in which the warm air flows.

As described above, in the first embodiment, the air conditioning case 14 configuring the vehicle air conditioning device 10 has the cool air passage 44 in which the evaporator 20 is housed, the warm air passage 46 in which the heater core 22 is housed, and the introduction space 32 provided between the cool air passage 44 and the warm air passage 46 communicates on the upstream side of the cool air passage 44 and the warm air passage 46 and in which air from the blower 18 is introduced via the air intake 16. The air introduced into this introduction space 32 branches to the cool air passage 44 and the warm air passage 46, and the introduction space 32 is provided with a switching door 24 that can control the flow amount of the air that flows to the cool air passage 44 and the warm air passage 46.

Therefore, when compared to the conventional vehicle air conditioning device wherein the heater core is disposed downstream from the evaporator and the air passes through the evaporator even when the air does not need to be cooled, for example, by flowing air introduced into the introduction space 32 to only the heater core 22 side by the switching operation of the switching door 24 and blocking the flow of air to the evaporator 20 side when a target temperature in the vehicle interior is higher than the temperature before being temperature controlled or when dehumidifying is unnecessary, the ventilation resistance that occurs when the air passes through the evaporator 20 can be reduced.

As a result, the vehicle air conditioning device 10 can realize improvements in blowing efficiency by reducing ventilation resistance of air flowing in the air conditioning case 14 in a blowing mode (blowing state) that does not require the heat exchange of air by the evaporator 20.

Furthermore, in the air conditioning case 14, because the first heat exchange portion 70 of the evaporator 20 and the second heat exchange portion 72 of the heater core 22 are disposed substantially parallel to face each other interposing the partition wall 26 separating the cool air passage 44 and the warm air passage 46, the vehicle air conditioning device 10 can be made smaller in the width direction.

Additionally, the switching door 24 is a plate door configured by the rotating shaft 74 supported by the air conditioning case 14 and the shielding portion 76 extending in a direction orthogonal to the shaft direction of the rotating shaft 74, and by disposing the switching door 24 including the rotating shaft 74 between the evaporator 20 and the heater core 22, the vehicle air conditioning device 10 can be made smaller in width direction (direction of arrows A1 and A2).

Moreover, using a plate door having a simple structure made of the rotating shaft 74 and the shielding portion 76 as the switching door 24 makes it possible to suitably reduce the ventilation resistance when air is introduced from the blower 18 into the introduction space 32 upstream from the evaporator 20 and the heater core 22.

Furthermore, in the air conditioning case 14, because the passage length of the cool air passage 44 in which cool air flows is formed longer than the passage length of the warm air passage 46 in which warm air flows, for example, even when moisture in the air passing through the evaporator 20 condenses and adheres as condensed water during a cooling operation and the condensed water is dispersed by the air passing through the first heat exchange portion 70, a sufficient passage length of the cool air passage 44 from the evaporator 20 to the vent duct 48 can be secured to prevent dispersed condensed water from infiltrating into the vehicle interior from the vent duct 48.

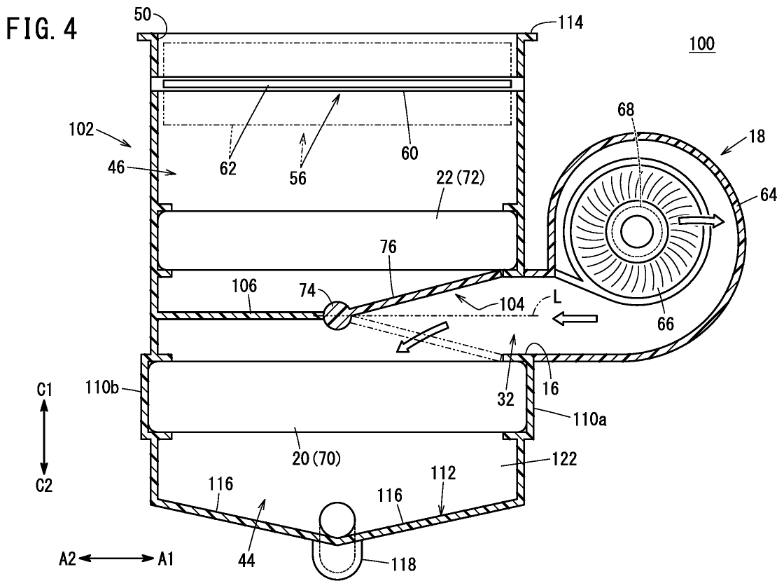

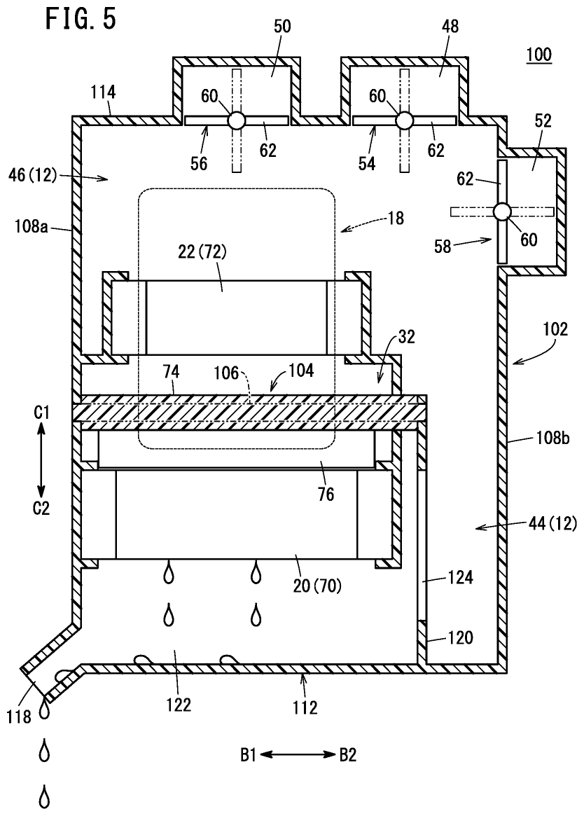

Next, a vehicle air conditioning device 100 according to the second embodiment is illustrated in FIG. 4 and FIG. 5. Note that the same reference numerals are given to constituent elements that are the same as those in the vehicle air conditioning device 10 according to the first embodiment described above, and detailed descriptions thereof will be omitted.

The vehicle air conditioning device 100 according to the second embodiment differs from the vehicle air conditioning device 10 according to the first embodiment in that it has a vertical structure wherein the evaporator 20 and the heater core 22 are disposed in parallel in the vertical direction (direction of arrows C1 and C2).

As illustrated in FIG. 4 and FIG. 5, the vehicle air conditioning device 100 has an air conditioning case 102 formed longer in the vertical direction, and in the air conditioning case 102, a switching door 104 and a partition wall (partition plate) 106 are provided substantially in the center in the vertical direction, and the evaporator 20 and the heater core 22 are disposed substantially parallel at a prescribed interval to be separated in the vertical direction (direction of arrows C1 and C2) interposing the switching door 104 and the partition wall 106. That is, the vehicle air conditioning device 100 has a vertical structure wherein the evaporator 20 and the heater core 22 are disposed in parallel in the vertical direction (longitudinal direction).

In the interior of the air conditioning case 102, the partition wall 106 extends horizontally and in a straight line from a side wall 110b on the other side in the width direction (direction of arrow A2) of the air conditioning case 102 to the substantial center in the width direction, and as illustrated in FIG. 5, stands reaching the vicinity of the substantial central portion toward the other side in the depth direction from a side wall 108a of the air conditioning case 102 on one side in the depth direction (direction of arrow B1) between the evaporator 20 and the heater core 22.

Furthermore, on the one side wall 110a of the air conditioning case 102 in the width direction, the air intake 16 is made to reach the switching door 104 and the partition wall 106, and the fan case 64 of the blower 18 mounted on the side wall 110a of the air conditioning case 102 is connected to this air intake 16.

Additionally, the interior of the air conditioning case 102 has a bottom wall 112 formed lower (direction of the arrow C2) and a ceiling wall 114 formed above the bottom wall 112 (direction of arrow C1), and the vehicle air conditioning device 100 is mounted so that the bottom wall 112 is lower in the weight direction (direction of arrow C2) with respect to the vehicle.

As illustrated in FIG. 4, this bottom wall 112 has a set of sloped surfaces 116 sloping downward in the weight direction (direction of arrow C2) from both ends in the width direction toward the center in the width direction, one sloped surface 116 and another sloped surface 116 are connected, and a drain port 118 communicating to the exterior is provided on the lowest end in the weight direction (direction of arrow C2). The drain port 118 is formed in a cylindrical shape and made opening toward the exterior, and is provided to be able to discharge moisture (condensed water) that has fallen to the bottom wall 112 of the air conditioning case 102 to the exterior.

Furthermore, in the interior of the air conditioning case 102, as illustrated in FIG. 4, the evaporator 20 and the heater core 22 are respectively disposed to be substantially horizontal along the width direction (direction of arrows A1 and A2) by having both ends in the width direction thereof respectively fixed to the air conditioning case 102, and as illustrated in FIG. 5, one end in the depth direction thereof is fixed to the side wall 108a on one side of the air conditioning case 102 in the depth direction (direction of arrow B1). The heater core 22 is disposed upward in the weight direction (direction of arrow C1) and the evaporator 20 is disposed downward in the weight direction (direction of arrow C2) with respect to the heater core 22, these being disposed separated from each other at a prescribed distance.

Additionally, as illustrated in FIG. 5, in the interior of the air conditioning case 102, a separating wall 120 is provided on the other side of the evaporator 20 in the depth direction (direction of arrow B2). The separating wall 120 extends in a straight line standing upward (direction of arrow C1) in relation to the bottom wall 112, and a communication hole 124 is formed reaching a housing chamber 122 in which the evaporator 20 is housed. The communication hole 124 penetrates the separating wall 120 in the depth direction, and joins the passage portion between the side wall 108b on the other side in the depth direction (direction of arrow B2) and the separating wall 120, and the housing chamber 122.

Additionally, the vent duct 48 and the defroster duct 50 are formed on the ceiling wall 114 on the top of the air conditioning case 102, and the heat duct 52 is formed on the side wall 108b on the other side in the depth direction (direction of arrow B2). The vent door 54, the defroster door 56, and the heat door 58 are provided on the vent duct 48, the defroster duct 50, and the heat duct 52, respectively, to be able to open and close.

The switching door 104 has a cantilever structure having the rotating shaft 74 and the plate-shaped shielding portion (shielding plate) 76 extending to the outside in the radial direction with respect to the rotating shaft 74, and the rotational shaft 74 extends in the depth direction (direction of arrows B1 and B2 in FIG. 5) of the air conditioning case 102 and is rotationally held respectively by the side wall 108a on one side in the depth direction (direction of arrow B1) and the separating wall 120, is disposed to be parallel to the evaporator 20 and the heater core 22, and is provided to be adjacent to the other end in the width direction of the partition wall 106 (see FIG. 4).

The shielding portion 76 is disposed on one side in the width direction (direction of arrow A1 in FIG. 4) with respect to the rotating shaft 74 in the air conditioning case 102, and by rotating the rotating shaft 74, rotation occurs at a prescribed angle from a position reaching the evaporator 20 to a position reaching the heater core 22 in the introduction space 32 provided between the evaporator 20 and the heater core 22.

Moreover, for example, in the introduction space 32, the shielding portion 76 is formed such that a rotation angle to the lower side in the weight direction (direction of arrow C2) on the side of the evaporator 20 illustrated and a rotation angle to the upper side in the weight direction (direction of arrow C1) on the side of the heater core 22 are the same with respect to the virtual line L extending the rotating shaft 74 and the partition wall 106 in the width direction (direction of arrows A1 and A2).

In the switching door 104, the rotating shaft 74 rotates under the driving operation of driving means for driving based on a control signal from a controller not illustrated in the drawings, and by the shielding portion 76 rotating in a prescribed direction in the introduction space 32 in accordance with said rotation, the flow state and flow amount of air introduced into the introduction space 32 can be controlled (switched) to the lower side in the weight direction (direction of arrow C2) and the upper side in the weight direction (direction of arrow C1).

The vehicle air conditioning device 100 according to the second embodiment of the present invention has the basic configuration described above, and the operation and action effect thereof will be described below.

First, when performing the warming operation for blowing warm air to the vicinity of the feet of an occupant, the driving means is driven based on a control signal from a controller not illustrated in the drawings, and the switching door 104 is rotated clockwise (lower side in the weight direction, direction of arrow C2) (see the double-dotted line shape in FIG. 4) around the rotating shaft 74 creating a state wherein the introduction space 32 and the heater core 22 communicate, and the heat door 58 is rotated to create a state wherein the heat duct 52 is open.

Air introduced into the introduction space 32 of the air conditioning case 102 via the air intake 16 under the driving operation of the blower 18 flows to the side of the opened heater core 22 (upper side in the weight direction in FIG. 4). Note that in the introduction space 32, air does not flow from the introduction space 32 to the evaporator 20 side because the evaporator 20 side (lower side in the weight direction in FIG. 4) is closed by the switching door 104.

Air in the introduction space 32 passes through the heater core 22 and therefore undergoes a heat exchange with the warm water in the second heat exchange portion 72 and is heated to become warm air, and this warm air flows upward in the weight direction (direction of arrow C1) from the downstream side of the heater core 22 in the warm air passage 46 and is blown from the open heat duct 52 to the vicinity of the feet of an occupant in the vehicle interior.

Next, when performing the cooling operation for blowing cool air to the vicinity of the face of an occupant, driving means not illustrated in the drawings rotates the switching door 104 counter-clockwise around the rotating shaft 74 (upper side in the weight direction, direction of arrow C1), creating a state wherein the introduction space 32 and the evaporator 20 communicate, and the vent door 54 is rotated to create a state wherein the vent duct 48 is open.

Air introduced into the introduction space 32 of the air conditioning case 102 via the air intake 16 under the driving operation of the blower 18 flows to the side of the opened evaporator 20 (lower side in the weight direction in FIG. 4). Note that in the introduction space 32, air does not flow from the introduction space 32 to the heater core 22 side because the heater core 22 side (upper side in the weight direction in FIG. 4) is closed by the switching door 104.

By air in the introduction space 32 passing through the evaporator 20, the air undergoes a heat exchange with the refrigerant and is cooled and becomes cool air, after this cool air flows into the housing chamber 122 lower in the weight direction (direction of arrow C2) in the air conditioning case 102 that will be the downstream side of the evaporator 20, the cool air flows upward in the weight direction (direction of arrow C1) between the separating wall 120 and the side wall 108b via the communication hole 124 of the separating wall 120 configuring the cool air passage 44, and is blown from the opened vent duct 48 to the vicinity of the face of an occupant in the vehicle interior.

That is, during the cooling operation of the vehicle air conditioning device 100, as illustrated in FIG. 5, the flow of air flowing from the introduction space 32 to the evaporator 20 flows downward in the weight direction (direction of arrow C2) and then reverses and flows upward in the weight direction (direction of arrow C1) along the separating wall 120. In other words, the passage length of the cool air passage 44 in which the cool air flows is formed to be longer than the passage length of the warm air passage 46 in which the warm air flows.

Furthermore, when performing heat exchange between the refrigerant and air in the evaporator 20, moisture included in the air may cool, become condensed water, and adhere, and this condensed water may disperse due to the flow of the air passing through the first heat exchange portion 70 and fall downward in the weight direction (direction of arrow C2), but the condensed water falls to the bottom wall 112 of the air conditioning case 102 due to the weight thereof and is suitably led to the drain port 118 by the sloped surface 116 and thereby discharged to the exterior.

As described above, in the second embodiment, the air conditioning case 102 configuring the vehicle air conditioning device 100 has the cool air passage 44 in which the evaporator 20 is housed, the warm air passage 46 in which the heater core 22 is housed, and the introduction space 32 provided between the cool air passage 44 and the warm air passage 46 communicates on the upstream side of the cool air passage 44 and the warm air passage 46 and in which air from the blower 18 is introduced via the air intake 16. The air introduced into this introduction space 32 branches to the cool air passage 44 and the warm air passage 46, and the introduction space 32 is provided with a switching door 104 that can control the amount of the air that flows to the cool air passage 44 and the warm air passage 46.

Therefore, when compared to the conventional vehicle air conditioning device wherein the heater core is disposed downstream from the evaporator and the air passes through the evaporator even when the air does not need to be cooled, for example, by flowing air introduced into the introduction space 32 to only the heater core 22 side by the switching operation of the switching door 104 and blocking the flow of air to the evaporator 20 side when a target temperature in the vehicle interior is higher than the temperature before being temperature controlled or when dehumidifying is unnecessary, the ventilation resistance that occurs when the air passes through the evaporator 20 can be reduced.

As a result, the vehicle air conditioning device 100 can realize improvements in blowing efficiency by reducing ventilation resistance of air flowing in the air conditioning case 14 in a blowing mode (blowing state) that does not require the heat exchange of air by the evaporator 20.

Furthermore, in the air conditioning case 102, because the passage length of the cool air passage 44 in which cool air flows is formed longer than the passage length of the warm air passage 46 in which warm air flows, for example, even when moisture in the air passing through the evaporator 20 condenses and adheres during the cooling operation and is dispersed by the air passing through the first heat exchange portion 70, a sufficient passage length of the cool air passage 44 from the evaporator 20 to the vent duct 48 can be secured to prevent dispersed condensed water from infiltrating into the vehicle interior from the vent duct 48.

Additionally, by the vent duct 48, the defroster duct 50, and the heat duct 52 being disposed further upward in the weight direction (direction of arrow C1) than the evaporator 20 in the air conditioning case 102, even when condensed water adhering to the evaporator 20 is dispersed by air passing through the first heat exchange portion 70, such can be prevented from reaching each duct against the weight direction, and infiltration in the vehicle interior can be more reliably prevented.

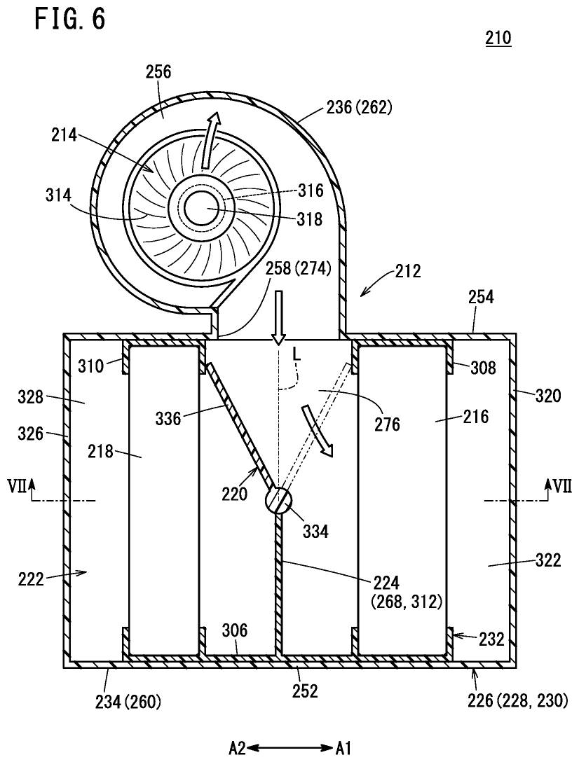

Next, a vehicle air conditioning device 210 according to the third embodiment is illustrated in FIG. 6 to FIG. 9.

As illustrated in FIG. 6 to FIG. 9, the vehicle air conditioning device 210 is provided with an air conditioning case 212, a blower 214, an evaporator (cooler) 216, a heater core (heater) 218, and a switching door 220. When the vehicle air conditioning device 210 is mounted in a vehicle, the evaporator 216 is disposed in the front of the vehicle (direction of arrow A1) and the heater core 218 is disposed in the rear of the vehicle (direction of arrow A2). The front is the direction heading toward the engine room in the vehicle in which the vehicle air conditioning device 210 is mounted. The rear is the direction heading toward the interior of the vehicle.

The air conditioning case 212 is formed from a resin-made material. The interior of the air conditioning case 212 has a passage 222. Air flows through the passage 222. The interior of the air conditioning case 212 is provided with a partition wall 224. The partition wall 224 is disposed substantially in the center in the longitudinal direction of the air conditioning case 212. In the interior of the air conditioning case 212, the switching door 220 is disposed to face the end portions of the partition wall 224. That is, the switching door 220 is disposed substantially in the center in the longitudinal direction of the air conditioning case 212.

In the interior of the air conditioning case 212, the evaporator 216 and the heater core 218 are disposed so as to be separated in the longitudinal direction (direction of arrows A1 and A2) interposing the switching door 220 and the partition wall 224. The evaporator 216 is disposed further to the front (direction of arrow A1) than the switching door 220 and the partition wall 224. The heater core 218 is disposed further to the rear (direction of arrow A2) than the switching door 220 and the partition wall 224.

The vehicle air conditioning device 210 has a horizontal structure wherein the evaporator 216 and the heater core 218 are disposed in parallel in the longitudinal direction (direction of arrows A1 and A2) in the air conditioning case 212.

The air conditioning case 212 is provided with a lower case (split case portion) 226, an intermediate case (split case portion) 228, an upper case (split case portion) 230, and an inner holder 232. The lower case 226, the intermediate case 228, and the upper case 230 can be split in the vertical direction (direction of arrows B1 and B2). That is, the air conditioning case 212 is configured from the lower case 226, the intermediate case 228, and the upper case 230 that can be split in the vertical direction.

The lower case 226 is disposed on the lowermost portion of the air conditioning case 212. The lower case 226 is provided with a first case main body 234 and a first blower housing portion 236. The lower case 226 opens upward (direction of arrow B1). The interior of the lower case 226 houses the lower portion of the evaporator 216, the lower portion of the heater core 218, and the lower portion of the inner holder 232.

The first case main body 234 has a substantial square shape when viewed from the top. The lower end of the first case main body 234 is provided with a bottom wall 238, a drain portion 240, and a foot duct (second duct) 242. The bottom wall 238 is disposed substantially in the center in the longitudinal direction of the lower case 226. The bottom wall 238 extends substantially in the horizontal direction.

The drain portion 240 is disposed in the front (direction of arrow A1) of the bottom wall 238. The drain portion 240 faces the lower end of the evaporator 216 described hereinafter. The drain portion 240 can accept condensed water (moisture) that occurs in the evaporator 216. The drain portion 240 projects downward (direction of arrow B2) from the bottom wall 238. The bottom surface of the drain portion 240 has a tapered shape gradually tapering downward from the bottom wall 238. The cross-sectional shape of the drain portion 240 is a triangular shape that is narrower heading downward (direction of arrow B2).

The lowest end of the drain portion 240 is disposed substantially in the center of the drain portion 240 along the longitudinal direction. The lower end of the drain portion 240 is provided with a drain port 244. The drain port 244 has a cylindrical shape. The drain port 244 projects downward (direction of arrow B2) from the lower end of the drain portion 240. The drain port 244 communicates with the interior of the drain portion 240. The drain port 244 communicates with the exterior of the lower case 226.

Thus, the condensed water that has fallen into the interior of the drain portion 240 is discharged to the exterior of the lower case 226 via the drain port 244.

The foot duct 242 is disposed in the rear of the bottom wall 238 (direction of arrow A2). The foot duct 242 opens along the width direction orthogonal to the longitudinal direction of the lower case 226. The foot duct 242 faces the lower end of the heater core 218. The foot duct 242 has a connection portion 242a projecting downward from the bottom wall 238. The connection portion 242a of the foot duct 242 is connected to an outlet in the vicinity of the feet of an occupant in the vehicle interior by a blowing duct not illustrated in the drawings. A foot damper 246 is attached inside the foot duct 242.

The foot damper 246 is disposed to be able to open and close the foot duct 242. The foot damper 246 can be rotated inside the foot duct 242. The foot damper 246 is disposed at substantially the same height as the bottom wall 238 inside the foot duct 242. The foot damper 246 is provided with a shaft 248 and a pair of door portions 250. The foot damper 246 is a butterfly-type door having the shaft 248 and the door portions 250.

The shaft 248 is supported by a first side wall 252 on one side of the width direction in the lower case 226 (see FIG. 6) and a second side wall 254 in the other side of the width direction (see FIG. 6). The shaft 248 can be rotated. The shaft 248 is rotationally driven by being linked to a driving source not illustrated in the drawings.

The pair of door portions 250 extends outward in the radial direction from the circumferential surface of the shaft 248. One door portion 250 and the other door portion 250 extend in opposite directions centering around the shaft 248. The one door portion 250 and the other door portion 250 are disposed in a straight line.

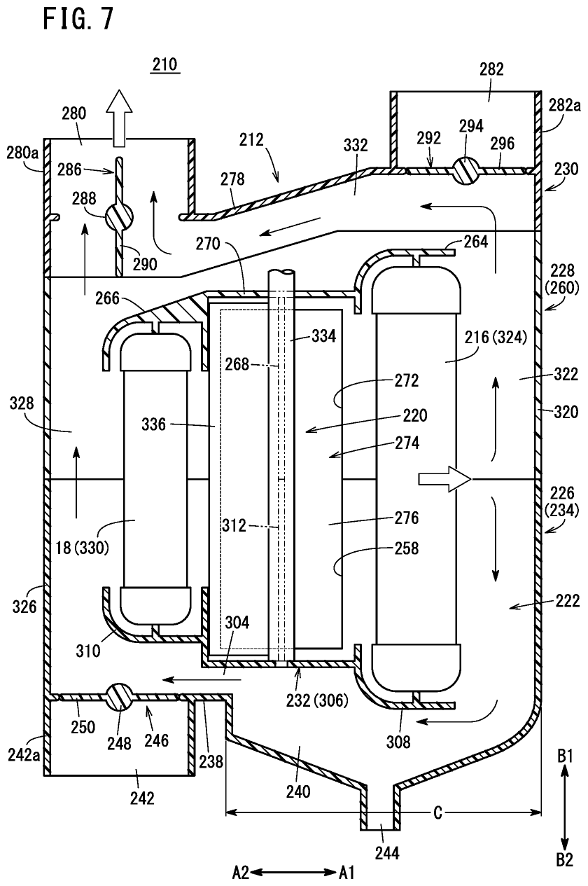

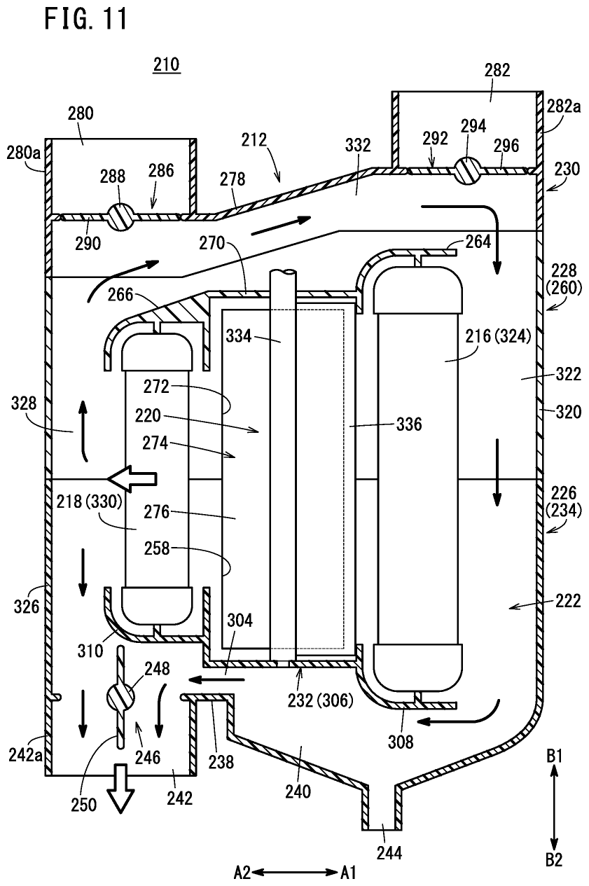

The foot damper 246 rotates in the interior of the foot duct 242 by a driving source not illustrated in the drawings being driven. Because the pair of door portions 250 are disposed along the longitudinal direction (direction of arrows A1 and A2) of the lower case 226, the foot duct 242 is closed according to the rotation of the foot damper 246 (see FIG. 7). Because the pair of door portions 250 are disposed along the vertical direction (direction of arrows B1 and B2), the foot duct 242 is opened according to the rotation of the foot damper 246 (see FIG. 11).

The first blower housing portion 236 can house a portion of the blower 214. The first blower housing portion 236 opens upward (direction of arrow B1). The first blower housing portion 236 has a substantially cylindrical shape extending in the vertical direction (direction of arrows B1 and B2). The first blower housing portion 236 is disposed on one side of the first case main body 234 in the width direction. The first blower housing portion 236 is connected to the second side wall 254 of the first case main body 234. The first blower housing portion 236 is connected substantially to the center in the longitudinal direction of the second side wall 254.

The blower 214 is inserted into the center of the first blower housing portion 236 via a hole portion not illustrated in the drawings. A portion of a blowing passage 256 is provided in the first blower housing portion 236. The blowing passage 256 has a coil-shape centering on the hole portion and the blower 214. The blowing passage 256 is gradually wider toward the outside in the radial direction from the upstream side to the downstream side. The downstream end of the blowing passage 256 is connected to the first air intake 258 of the first case main body 234. The first air intake 258 has a rectangular shape extending along the vertical direction (direction of arrows B1 and B2) of the second side wall 254. The blowing passage 256 and the interior of the first case main body 234 communicate via the first air intake 258.

The intermediate case 228 is disposed on the upper portion of the lower case 226. The intermediate case 228 is disposed between the lower case 226 and the upper case 230 in the air conditioning case 212. The intermediate case 228 is provided with a second case main body 260 and a second blower housing portion 262. The intermediate case 228 opens in the vertical direction (direction of arrows B1 and B2). The interior of the intermediate case 228 houses the upper portion of the evaporator 216, the upper portion of the heater core 218, and the upper portion of the inner holder 232.

The second case main body 260 has a substantial square shape when viewed from the top. When viewing the air conditioning case 212 from the top, the second case main body 260 and the first case main body 234 have the same shape. The lower end of the second case main body 260 is connected to the upper end of the first case main body 234.

The upper end of the second case main body 260 faces the upper portion of the evaporator 216 in the front. The upper end of the second case main body 260 faces the upper portion of the heater core 218 in the rear. The upper end of the second case main body 260 has a central portion connecting the front and the rear. The central portion is sloped to connect the upper end at the front and the upper end at the rear.

The interior of the second case main body 260 is provided with a first upper holding portion 264, a second upper holding portion 266, and an upper partition piece 268. The first and second upper holding portions 264 and 266 respectively extend along the width direction orthogonal to the longitudinal direction of the second case main body 260.

The first upper holding portion 264 is disposed in the front of a second air intake 272 described hereinafter (direction of arrow A1). The first upper holding portion 264 is disposed above (direction of arrow B1) the upper end of the second air intake 272. The first upper holding portion 264 can hold the upper end of the evaporator 216.

The second upper holding portion 266 is disposed in the rear (direction of arrow A2) of the second air intake 272 described hereinafter. The second upper holding portion 266 is disposed below (direction of arrow B2) the upper end of the second air intake 272. The second upper holding portion 266 can hold the upper end of the heater core 218.

The upper partition piece 268 configures a portion of the partition wall 224. The upper partition piece 268 is disposed substantially in the center in the longitudinal direction of the intermediate case 228. The upper partition piece 268 is disposed between the first upper holding portion 264 and the second upper holding portion 266. The upper partition piece 268 is connected to an upper connection portion 270 connecting the first upper holding portion 264 and the second upper holding portion 266. The upper partition piece 268 extends in a straight line downward (direction of arrow B2) from the upper connection portion 270.

The upper partition piece 268 faces the second air intake 272. The upper partition piece 268 faces the center of the second air intake 272 in the longitudinal direction. The lower end of the upper partition piece 268 and the lower end of the intermediate case 228 are at the same position in the vertical direction (direction of arrows B1 and B2). The lower end of the upper partition piece 268 is connected to the upper end of a lower partition piece 312 of the inner holder 232 described hereinafter.

The second blower housing portion 262 can house the upper portion of the blower 214. The second blower housing portion 262 opens downward (direction of arrow B2). The second blower housing portion 262 has a substantially cylindrical shape extending in the vertical direction. The second blower housing portion 262 is disposed on one side of the second case main body 260 in the width direction. The second blower housing portion 262 is connected to the center in the longitudinal direction of the second side wall 254.

The second blower housing portion 262 is disposed above (direction of arrow B1) the first blower housing portion 236. The lower end of the second blower housing portion 262 is connected to the upper end of the first blower housing portion 236. The interior of the second blower housing portion 262 houses a fan 314 of the blower 214. That is, the lower case 226 and the intermediate case 228 are configured to be able to be split in the vertical direction (direction of arrows B1 and B2).

A portion of the blowing passage 256 is provided in the second blower housing portion 262. The blowing passage 256 spans over the first blower housing portion 236 and the second blower housing portion 262. The downstream end of the blowing passage 256 in the second blower housing portion 262 is connected to the second air intake 272 of the second case main body 260. The second air intake 272 has a rectangular shape extending along the vertical direction (direction of arrows B1 and B2) of the second side wall 254. The lower end of the second air intake 272 and the upper end of the first air intake 258 are connected. The first air intake 258 and the second air intake 272 are connected to configure one air intake 274. The air intake 274 opens to the second side wall 254 of the intermediate case 228 and the lower case 226. The air intake 274 is a rectangular shape longer in the vertical direction. The interior of the first and second case main bodies 234 and 260 and the blowing passage 256 communicate via the air intake 274.

The interior of the intermediate case 228 and the lower case 226 are provided with an introduction passage 276. The introduction passage 276 is disposed in the center in the longitudinal direction of the intermediate case 228 and the lower case 226. The introduction passage 276 communicates with the air intake 274. The introduction passage 276 extends toward one direction in the width direction from the second side wall 254 of the intermediate case 228 and the lower case 226. The introduction passage 276 is disposed between the evaporator 216 and the heater core 218. Air taken into the blower 214 is introduced to the introduction passage 276 from the blowing passage 256 via the air intake 274.

The upper case 230 is disposed on the upper portion of the intermediate case 228. The upper case 230 is disposed on the uppermost portion on the air conditioning case 212. The upper case 230 covers the upper portion of the second case main body 260 in the intermediate case 228. The upper case 230 has a substantial square shape when viewed from the top. When viewing the air conditioning case 212 from the top, the upper case 230 and the first and second case main bodies 234 and 260 have the same shape.

The lower end of the upper case 230 has a stepped shape corresponding to the upper end of the second case main body 260. The lower end of the upper case 230 is connected to the upper end of the second case main body 260. That is, the upper case 230 and the intermediate case 228 are configured to be able to be split in the vertical direction (direction of arrows B1 and B2).

The upper end of the upper case 230 is provided with a ceiling wall 278, a face duct (first duct) 280, a defroster duct (first duct) 282, and an attachment portion 284. The ceiling wall 278 is disposed substantially in the center in the longitudinal direction of the upper case 230. The ceiling wall 278 slopes upward toward the front (direction of arrow A1).

The face duct 280 is disposed in the rear of the ceiling wall 278 (direction of arrow A2). The face duct 280 opens along the width direction orthogonal to the longitudinal direction of the upper case 230. The face duct 280 faces the upper end of the heater core 218. The face duct 280 has a connection portion 280a projecting upward (direction of arrow B1) from the ceiling wall 278. The connection portion 280a of the face duct 280 is connected to an outlet in the vicinity of the face of an occupant in the vehicle interior by a blowing duct not illustrated in the drawings.

A face damper 286 is attached inside the face duct 280. The face damper 286 is disposed to be able to open and close the face duct 280. The face damper 286 can be rotated inside the face duct 280. The face damper 286 is provided with a shaft 288 and a pair of door portions 290. Similar to the foot damper 246, the face damper 286 is a butterfly-type door having the shaft 288 and the door portions 290.

The shaft 288 is supported by the first side wall 252 on one side of the width direction in the upper case 230 (see FIG. 6) and the second side wall 254 in the other side of the width direction (see FIG. 6). The shaft 288 can be rotated. The shaft 288 is rotationally driven by being linked to a driving source not illustrated in the drawings.

The pair of door portions 290 extends outward in the radial direction from the circumferential surface of the shaft 288. One door portion 290 and the other door portion 290 extend in opposite directions centering around the shaft 288. The one door portion 290 and the other door portion 290 are disposed in a straight line.

The face damper 286 rotates in the interior of the face duct 280 by a driving source not illustrated in the drawings being driven. Because the pair of door portions 290 are disposed along the longitudinal direction (direction of arrows A1 and A2) of the upper case 230, the face duct 280 is closed according to the rotation of the face damper 286 (see FIG. 11). Because the pair of door portions 290 are disposed along the vertical direction (direction of arrows B1 and B2), the face duct 280 is opened according to the rotation of the face damper 286 (see FIG. 7).

The defroster duct 282 is disposed in the front of the ceiling wall 278 (direction of arrow A1). The defroster duct 282 opens along the width direction orthogonal to the longitudinal direction of the upper case 230. The defroster duct 282 faces the upper end of the evaporator 216. The defroster duct 282 has a connection portion 282a projecting upward from the ceiling wall 278. The connection portion 282a of the defroster duct 282 is connected to an outlet in the vicinity of the front window in the vehicle interior by a blowing duct not illustrated in the drawings.

A defroster damper 292 is attached inside the defroster duct 282. The defroster damper 292 is disposed to be able to open and close the defroster duct 282. A defroster damper 292 can be rotated inside the defroster duct 282. The defroster damper 292 is provided with a shaft 294 and a pair of door portions 296. Similar to the foot damper 246 and the face damper 286, the defroster damper 292 is a butterfly-type door having the shaft 294 and the door portions 296.

The shaft 294 is supported by the first side wall 252 on one side of the width direction in the upper case 230 (see FIG. 6) and the second side wall 254 in the other side of the width direction (see FIG. 6). The shaft 294 can be rotated. The shaft 294 is rotationally driven by being linked to a driving source not illustrated in the drawings.

The pair of door portions 296 extends outward in the radial direction from the circumferential surface of the shaft 294. One door portion 296 and the other door portion 296 extend in opposite directions centering around the shaft 294. The one door portion 296 and the other door portion 296 are disposed in a straight line.

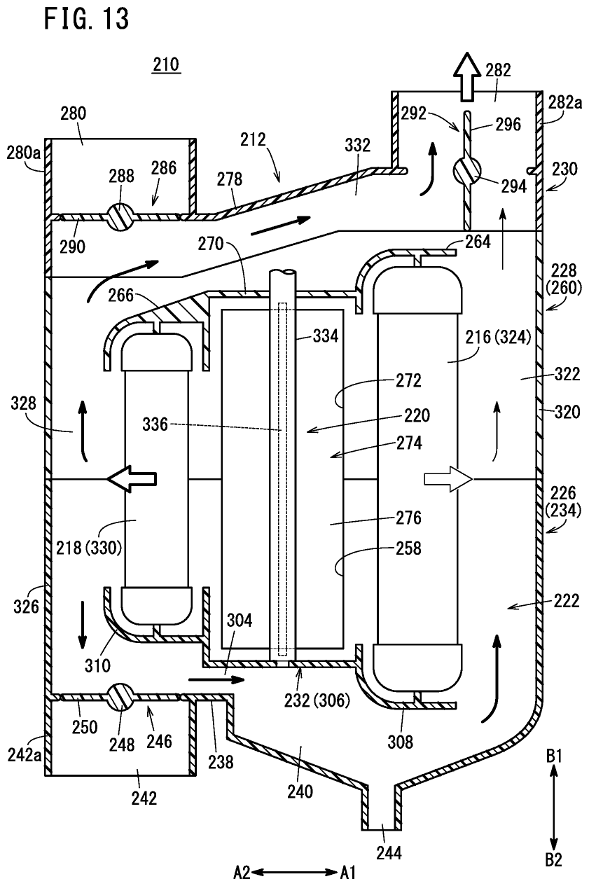

The defroster damper 292 rotates in the interior of the defroster duct 282 by a driving source not illustrated in the drawings being driven. Because the pair of door portions 296 are disposed along the longitudinal direction (direction of arrows A1 and A2) of the upper case 230, the defroster duct 282 is closed according to the rotation of the defroster damper 292 (see FIG. 7). Because the pair of door portions 296 are disposed along the vertical direction (direction of arrows B1 and B2), the defroster duct 282 is opened according to the rotation of the defroster damper 292 (see FIG. 13).

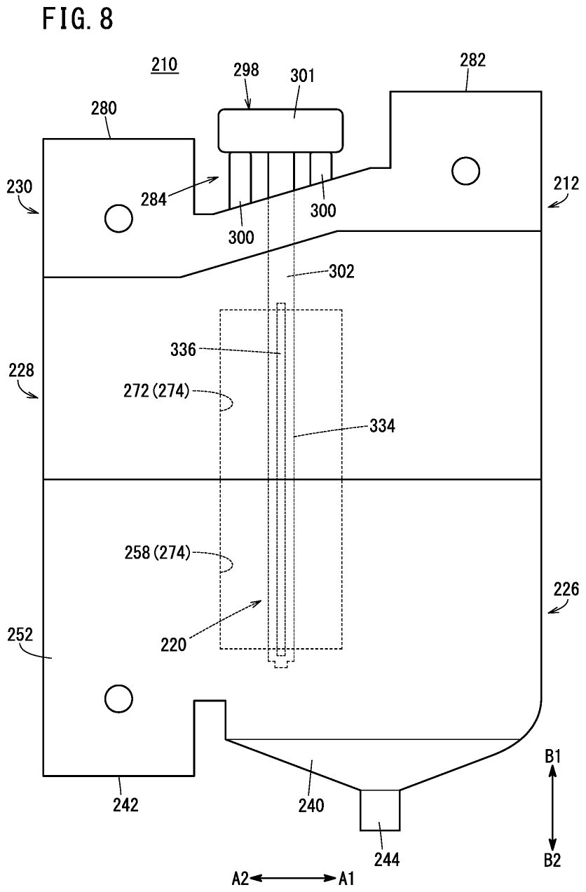

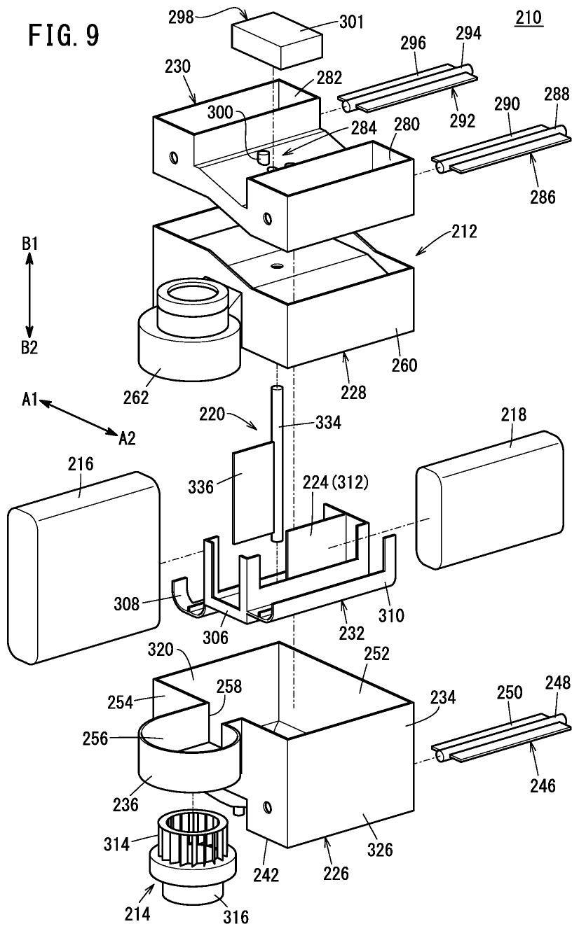

As illustrated in FIG. 8 and FIG. 9, the attachment portion 284 can attach an actuator (driving source) 298. The attachment portion 284 is disposed between the face duct 280 and the defroster duct 282. The attachment portion 284 is provided with a plurality of attachment bosses 300. The attachment bosses 300 projects upward (direction of arrow B1) from the ceiling wall 278. Each attachment boss 300 is disposed separated from the others. The plurality of attachment bosses 300 have substantially the same height. The actuator 298 is attached to the upper end of the plurality of attachment bosses 300.

The actuator 298 can be driven by a control signal from a controller not illustrated in the drawings. The actuator 298 rotates the switching door 220. The actuator 298 is provided with a housing 301 and a driving shaft 302. A rotating driving mechanism not illustrated in the drawings is housed in the housing 301. The housing 301 is mounted on the upper end of the attachment bosses 300. The housing 301 is fixed to the upper end of the attachment bosses 300 from above by a tightening bolt not illustrated in the drawings. The driving shaft 302 projects from the center of the housing 301. The driving shaft 302 rotates by driving the rotating driving mechanism not illustrated in the drawings. The driving shaft 302 extends toward the upper case 230. The lower end of the driving shaft 302 is linked to a door shaft 334 of the switching door 220.

As illustrated in FIG. 6 to FIG. 9, the inner holder 232 is housed in the lower case 226. The inner holder 232 can hold the lower end of the evaporator 216 and the lower end of the heater core 218. The inner holder 232 is disposed separated a prescribed distance upward (direction of arrow B1) from the bottom wall 238 of the lower case 226. In the air conditioning case 212, a lower passage 304 is provided between the inner holder 232 and the bottom wall 238. The lower passage 304 is a portion of the passage 222.

The lower passage 304 extends in the longitudinal direction (direction of arrows A1 and A2) along the lower case 226. The lower passage 304 is connected to the lower portion of a front passage 322 described hereinafter and communicates to the front passage 322. The lower passage 304 is connected to the lower portion of a rear passage 328 described hereinafter and communicates to the rear passage 328. The front passage 322 and the rear passage 328 are connected and communicate via the lower passage 304. The front of the lower passage 304 faces the drain portion 240. The lower passage 304 communicates with the foot duct 242.

The inner holder 232 extends along the longitudinal direction (direction of arrows A1 and A2) of the lower case 226. The inner holder 232 opens along the width direction of the lower case 226 orthogonal to the longitudinal direction of the lower case 226. The inner holder 232 faces the lower end of the air intake 274 (first air intake 258), the lower end of the evaporator 216, and the lower end of the heater core 218. The inner holder 232 is provided with a holder main body 306, a first lower holding portion 308, a second lower holding portion 310, and the lower partition piece 312.

The holder main body 306 faces the lower end of the first air intake 258. The holder main body 306 surrounds the lower end of the first air intake 258. The lower portion of the holder main body 306 and the bottom wall 238 of the lower case 226 are substantially parallel. The length of the holder main body 306 along the longitudinal direction is substantially the same as the length of the first air intake 258 along the longitudinal direction.

The first lower holding portion 308 is disposed further to the front (direction of arrow A1) than the holder main body 306. The first lower holding portion 308 and the holder main body 306 are connected. The first lower holding portion 308 is disposed below (direction of arrow B2) the holder main body 306. The first lower holding portion 308 faces the lower end of the evaporator 216. The first lower holding portion 308 faces the substantial center of the drain portion 240 in the longitudinal direction. In other words, the first lower holding portion 308 is disposed between the evaporator 216 and the drain portion 240 in the vertical direction (direction of arrows B1 and B2) of the air conditioning case 212.

The lower end of the evaporator 216 is inserted into the first lower holding portion 308. The first lower holding portion 308 can hold the lower end of the evaporator 216.

The second lower holding portion 310 is disposed further to the rear than the holder main body 306 (direction of arrow A2). The second lower holding portion 310 and the holder main body 306 are connected. The second lower holding portion 310 is disposed above (direction of arrow B1) the holder main body 306. The second lower holding portion 310 faces the lower end of the heater core 218. The second lower holding portion 310 faces the foot duct 242. The second lower holding portion 310 is disposed between the heater core 218 and the foot duct 242 in the vertical direction (direction of arrows B1 and B2) of the air conditioning case 212.

The cross-sectional shape of the second lower holding portion 310 is a U-shape opening upward (direction of arrow B1). The lower end of the heater core 218 is inserted into the second lower holding portion 310. The second lower holding portion 310 can hold the lower end of the heater core 218.

The lower partition piece 312 configures a portion of the partition wall 224. The lower partition piece 312 extends in a straight line upward (direction of arrow B1) from the holder main body 306. The lower partition piece 312 is plate-shaped. The lower partition piece 312 is disposed substantially in the center in the longitudinal direction of the inner holder 232. The lower partition piece 312 is disposed between the first lower holding portion 308 and the second lower holding portion 310.

The lower partition piece 312 faces the first air intake 258 (air intake 274). The lower partition piece 312 faces the center of the first air intake 258 in the longitudinal direction. The upper end of the lower partition piece 312 and the upper end of the lower case 226 are at the same position in the vertical direction (direction of arrows B1 and B2). The upper end of the lower partition piece 312 is connected to the lower end of the upper partition piece 268 of the intermediate case 228. Thus, the lower partition piece 312 and the upper partition piece 268 are disposed in a straight line in the vertical direction (direction of arrows B1 and B2). The partition wall 224 is configured by the lower partition piece 312 and the upper partition piece 268. The partition wall 224 is disposed in the interior of the introduction passage 276. The partition wall 224 extends in the width direction orthogonal to the longitudinal direction in the air conditioning case 212. A portion of the introduction passage 276 is split in two in the longitudinal direction by the partition wall 224.

The blower 214 is mounted on the first and second blower housing portions 236 and 262. The blower 214 is provided with the fan 314 and a motor 316. The fan 314 has a cylindrical shape having a plurality of blades along the peripheral surface of the fan 314. The center of the fan 314 is linked to a rotating shaft 318 of the motor 316. The fan 314 is housed in the blowing passage 256. The fan 314 is housed in the center off the first and second blower housing portions 236 and 262. The motor 316 is attached to the exterior of the first blower housing portion 236.

When a control signal is input to the blower 214 from a controller not illustrated in the drawings the motor 316 drives and the fan 314 rotates along with the rotating shaft 318. Air from the exterior of the second blower housing portion 262 is taken into the blowing passage 256 in accordance with the rotation of the fan 314. Air flows along the blowing passage 256 and is supplied from the air intake 274 into the air conditioning case 212.

The evaporator 216 is disposed further to the front (direction of arrow A1) than the switching door 220 and the partition wall 224 in the air conditioning case 212. The evaporator 216 is disposed separated a prescribed distance from the switching door 220 and the partition wall 224. The evaporator 216 and the partition wall 224 are disposed to be substantially parallel.

The lower end of the evaporator 216 is held by the first lower holding portion 308 of the inner holder 232. The lower end of the evaporator 216 faces the drain portion 240. The upper end of the evaporator 216 is held by the first upper holding portion 264 of the intermediate case 228. The upper end of the evaporator 216 faces the defroster duct 282. The evaporator 216 is housed to span over the lower case 226 and the intermediate case 228. The evaporator 216 is disposed to the front (direction of arrow A1) separated a prescribed distance from the air intake 274.

The front passage (cool air passage) 322 is provided between the evaporator 216 and a front wall 320 of the air conditioning case 212. The front passage 322 extends along the vertical direction (direction of arrows B1 and B2). The front passage 322 is disposed in a straight line along the vertical direction. The lower end of the front passage 322 faces the drain portion 240. The lower end of the front passage 322 is connected to the lower passage 304 and communicates with the lower passage 304. The upper end of the front passage 322 faces the defroster duct 282 and communicates with the defroster duct 282. The front passage 322 is a portion of the passage 222.

The evaporator 216 is provided with a first heat exchange portion 324. Refrigerant can be circulated in the first heat exchange portion 324. Air flowing in the passage 222 can pass through the interior of the first heat exchange portion 324. A heat exchange occurs between the coldness of the refrigerant circulating in the first heat exchange portion 324 and the air passing through the first heat exchange portion 324. Thus, the air passing through the first heat exchange portion 324 is cooled by the coldness of the refrigerant and becomes cool air.

The heater core 218 is disposed further to the rear (direction of arrow A2) than the switching door 220 and the partition wall 224 in the air conditioning case 212. The heater core 218 is disposed separated a prescribed distance from the switching door 220 and the partition wall 224. The heater core 218 and the partition wall 224 are substantially parallel.

The lower end of the heater core 218 is held by the second lower holding portion 310 of the inner holder 232. The lower end of the heater core 218 faces the foot duct 242. The upper end of the heater core 218 is held by the second upper holding portion 266 of the intermediate case 228. The upper end of the heater core 218 faces the face duct 280. The heater core 218 is housed to span over the lower case 226 and the intermediate case 228. The heater core 218 is disposed to the rear (direction of arrow A2) separated a prescribed distance from the air intake 274.

A rear passage 328 is provided between the heater core 218 and a rear wall 3126 of the air conditioning case 212. The rear passage 328 extends along the vertical direction (direction of arrows B1 and B2). The rear passage 328 is disposed in a straight line along the vertical direction. The lower end of the rear passage 328 faces the foot duct 242 and communicates with the foot duct 242. The lower end of the rear passage 328 is connected to the lower passage 304 and communicates with the lower passage 304. The upper end of the rear passage 328 faces and communicates with the face duct 280. The rear passage 328 is a portion of the passage 222.

The heater core 218 is connected via piping to a cooling water circuit in the internal combustion engine in a vehicle not illustrated in the drawings. The heater core 218 is provided with a second heat exchange portion 330. Warm water (cooling water) supplied from an internal combustion engine not illustrated in the drawings can be circulated in the second heat exchange portion 330. Air flowing in the passage 222 can pass through the interior of the second heat exchange portion 330. A heat exchange occurs between the warmness of the warm water circulating in the second heat exchange portion 330 and the air passing through the second heat exchange portion 330. Thus, the air passing through the second heat exchange portion 330 is heated by the warmness of the warm water and becomes warm air.

An upper passage 332 is provided between the upper end of the evaporator 216, the upper end of the heater core 218, and the upper case 230. The upper passage 332 spans across the upper case 230 and the intermediate case 228. The upper passage 332 extends in the longitudinal direction (direction of arrows A1 and A2) along the upper case 230. The upper passage 332 is connected to the upper portion of a front passage 322 and communicates to the front passage 322. The upper passage 332 is connected to the upper portion of the rear passage 328 and communicates to the rear passage 328. The upper passage 332 is a portion of the passage 222.

The front passage 322 and the rear passage 328 are connected and communicate via the upper passage 332. The upper passage 332 communicates with the face duct 280. The upper passage 332 communicates with the defroster duct 282. The minimum passage cross-sectional area in the upper passage 332 is larger than the minimum passage cross-sectional area in the lower passage 304 (see FIG. 7) For example, the passage cross-sectional area of the upper passage 332 is at a minimum near the vicinity of the upper connection portion 270 in the intermediate case 228. The passage cross-sectional area of the lower passage 304 is at a minimum between the holder main body 306 and the bottom wall 238.

The first heat exchange portion 324 of the evaporator 216 and the second heat exchange portion 330 of the heater core 218 are disposed facing each other interposing the switching door 220 and the partition wall 224 (see FIG. 7).

The switching door 220 is disposed in the introduction passage 276. The switching door 220 is disposed spanning over the lower case 226 and the intermediate case 228 The switching door 220 faces the partition wall 224. The switching door 220 is disposed on the other side in the width direction on the partition wall 224. The switching door 220 is disposed on a position facing the air intake 274 in the introduction passage 276. The switching door 220 is provided with the door shaft 334 and a shielding portion 336. The switching door 220 is a cantilever system having the door shaft 334 and the shielding portion 336.

The door shaft 334 extends along the vertical direction (direction of arrows B1 and B2) of the air conditioning case 212. The door shaft 334 is adjacent to the other end of the partition wall 224 in the width direction. The lower end of the door shaft 334 is supported by the holder main body 306 of the inner holder 232. The upper end of the door shaft 334 is supported by the upper connection portion 270 of the intermediate case 228. Thus, the door shaft 334 is rotatably disposed in the air conditioning case 212.

The upper end of the door shaft 334 is disposed on the same axis of the driving shaft 302 of the actuator 298. The upper end of the door shaft 334 is linked to the driving shaft 302. Thus, the actuator 298 drives and the driving shaft 302 rotates, thereby rotating the door shaft 334 along with the driving shaft 302.

The shielding portion 336 is plate-shaped. The shielding portion 336 extends outward in the radial direction from the circumferential surface of the door shaft 334. The shielding portion 336 is disposed further to the other side in the width direction than the door shaft 334. That is, the shielding portion 336 faces the second side wall 254 of the air conditioning case 212 (see FIG. 6). The shielding portion 336 rotates along with the door shaft 334. The shielding portion 336 rotates a prescribed angle centered around the door shaft 334 in the introduction passage 276. The range of rotation of the shielding portion 336 is from a position where an end portion of the shielding portion 336 approaches the evaporator 216 to a position where the end portion of the shielding portion 336 approaches the heater core 218.

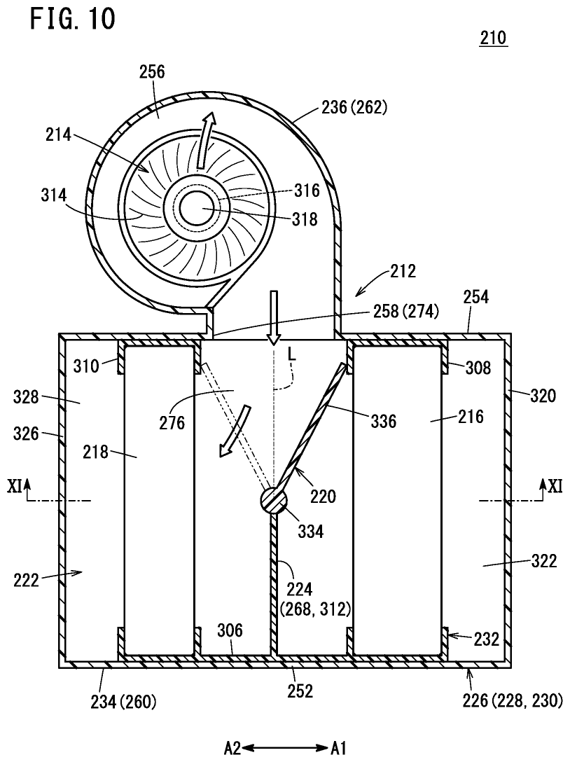

In the introduction passage 276, a rotation angle when the shielding portion 336 illustrated in FIG. 10 rotates to a maximum toward the evaporator 216 and a rotation angle when the shielding portion 336 illustrated in FIG. 6 is rotated to a maximum toward the heater core 218 are the same with respect to the virtual line L extending through the center of the door shaft 334 in the width direction orthogonal to the axial direction of the door shaft 334.

The actuator 298 drives based on the control signal from a controller not illustrated in the drawings, and the switching door 220 thereby rotates such that the shielding portion 336 faces a prescribed direction along with the door shaft 334 in the introduction passage 276.

When air is introduced from the blower 214 to the introduction passage 276 via the air intake 274, the flow direction and flow amount of the air can be controlled (switched) by the switching door 220 rotating.

Next, a description will be given of when the vehicle air conditioning device 210 is assembled.

As illustrated in FIG. 9, first, the lower case 226, the intermediate case 228, and the upper case 230 in the air conditioning case 212 are disposed in order along the vertical direction. The blower 214 is inserted from below into the first blower housing portion 236 of the lower case 226. The blower 214 is then fixed to the first blower housing portion 236. Thus, the fan 314 of the blower 214 is housed in the interior of the first blower housing portion 236.

Next, the inner holder 232 is housed in the interior of the first case main body 234 of the lower case 226, and is disposed in a position facing the first air intake 258. The inner holder 232 is disposed to extend along the width direction of the lower case 226. The inner holder 232 is fixed to the lower case 226.

The lower end of the evaporator 216 is inserted into the interior of the lower case 226 from the top of the lower case 226, and this lower end is inserted into the first lower holding portion 308 of the inner holder 232 from the top. The lower end of the heater core 218 is inserted into the interior of the lower case 226 from the top of the lower case 226, and this lower end is inserted into the second lower holding portion 310 of the inner holder 232 from the top. Thus, the lower end of the evaporator 216 and the lower end of the heater core 218 are housed in the interior of the lower case 226. The lower end of the evaporator 216 and the lower end of the heater core 218 are held by the inner holder 232.

The switching door 220 is inserted into the interior of the lower case 226 from the top of the lower case 226, and the lower end of the door shaft 334 is inserted into the hole portion (not illustrated in the drawings) of the holder main body 306 of the inner holder 232. Thus, the switching door 220 is held by the inner holder 232 to be able to be rotated by the door shaft 334. The door shaft 334 of the switching door 220 is disposed extending in the vertical direction.

The foot damper 246 is inserted into and rotatably fixed to the foot duct 242.

Next, the intermediate case 228 is brought closer to the lower case 226 from the top of the lower case 226. The lower end of the intermediate case 228 is made to contact and is connected to the upper end of the lower case 226. The upper end of the evaporator 216 is inserted into and held by the first upper holding portion 264. The upper end of the heater core 218 is inserted into and held by the second upper holding portion 266. The upper end of the door shaft 334 in the switching door 220 is rotatably supported by the upper connection portion 270. The upper end of the door shaft 334 projects further upward (direction of arrow B1) than the upper end of the intermediate case 228.

The upper partition piece 268 of the intermediate case 228 and the lower partition piece 312 of the lower case 226. The partition wall 224 is created by the upper partition piece 268 and the lower partition piece 312.

The lower end of the second blower housing portion 262 is made to come into contact with the upper end of the first blower housing portion 236. The second blower housing portion 262 covers the upper portion of the first blower housing portion 236. Thus, the fan 314 of the blower 214 is housed in the interior of the first and second blower housing portions 236 and 262. The blowing passage 256 is formed in the interior of the first and second blower housing portions 236 and 262.

Next, the upper end of the intermediate case 228 and the lower end of the upper case 230 are made to approach each other in the vertical direction. The lower end of the upper case 230 is made to contact and is connected to the upper end of the intermediate case 228. Thus, the face duct 280 of the upper case 230 is disposed on the top (direction of arrow B1) of the heater core 218 and is opened. The defroster duct 282 of the upper case 230 is disposed and opens on the top (direction of arrow B1) of the evaporator 216.

Next, the face damper 286 and the defroster damper 292 are attached to the upper case 230. Specifically, the face damper 286 is inserted into the face duct 280. Thus, the face damper 286 is rotatably supported in the interior of the face duct 280. The defroster damper 292 is inserted into the defroster duct 282. Thus, the defroster damper 292 is rotatably supported in the interior of the defroster duct 282.

The actuator 298 is attached to the attachment portion 284 of the upper case 230 from the top. The housing 301 of the actuator 298 is fixed to the attachment boss 300 by a tightening bolt not illustrated in the drawings.

Thus, the air conditioning case 212 of the vehicle air conditioning device 210 can assemble the lower case 226, the intermediate case 228, and the upper case 230 in the vertical direction. The evaporator 216, the heater core 218, and the switching door 220 can be assembled in the vertical direction with respect to the inner holder 232 and the intermediate case 228. The blower 214 can be assembled from below on the first blower housing portion 236 of the lower case 226. That is, the vehicle air conditioning device 210 can be assembled in the same direction (vertical direction).

Next, a description will be given of the operation and effects of the vehicle air conditioning device 210.

First, a description will be given when a face mode (cooling operation) is selected for blowing cool air to the vicinity of the face of an occupant in the vehicle interior illustrated in FIG. 6 and FIG. 7.

The actuator 298 is driven based on a control signal from a controller not illustrated in the drawings. The door shaft 334 of the switching door 220 rotates counter-clockwise due to the driving force from the driving shaft 302 in accordance with the driving of the actuator 298. The shielding portion 336 moves toward the heater core 218 due to the rotation of the switching door 220. Thus, the introduction passage 276 and the evaporator 216 communicate. The communication between the introduction passage 276 and the heater core 218 is blocked by the shielding portion 336 of the switching door 220.

The face damper 286 is rotated by a driving device not illustrated in the drawings to open the face duct 280. At this time, the defroster duct 282 and the foot duct 242 are closed.

The blower 214 is energized to drive the motor 316, thereby rotating the fan 314. Air from the exterior of the air conditioning case 212 is taken into the first and second blower housing portions 236 and 262 in accordance with the rotation of the fan 314. The air flows along the blowing passage 256. The air is supplied downstream from the blowing passage 256 to the introduction passage 276 of the air conditioning case 212 via the air intake 274.

The air flows from the introduction passage 276 toward the opened evaporator 216. The air passes through the first heat exchange portion 324 of the evaporator 216. At this time, a heat exchange occurs between the refrigerant circulating in the first heat exchange portion 324 and the air passing through the first heat exchange portion 324. The air is cooled by the coolness of the refrigerant and becomes cool air. This cool air flows to the front passage 322 downstream from the evaporator 216 The cool air flows along the front passage 322 being split in the vertical direction. The cool air on the upper side flowing upward (direction of arrow B1) flows along the upper passage 332 toward the rear (direction of arrow A2). After the cool air on the upper side flows to the rear passage 328, the cool air is supplied to the opened face duct 280.

The cool air on the lower side flowing downward (direction of arrow B2) along the front passage 322 flows along the lower passage 304 toward the rear (direction of arrow A2). After the cool air on the lower side flows to the rear passage 328, the cool air flows upward (direction of arrow B1) along the rear passage 328 and is supplied to the face duct 280. The cool air on the upper side and the cool air on the lower side are supplied to the face duct 280 via respectively different paths. The cool air on the upper side and the cool air on the lower side join each other at the face duct 280 and are blown from the face duct 280 to the vicinity of the face of an occupant in the vehicle interior as cool air. That is, the cool air flows toward the face duct 280 from the two directions on the upper side and the lower side going around the evaporator 216, the introduction passage 276, and the heater core 218.

In the face mode of the vehicle air conditioning device 210 described above, when air passes through the first heat exchange portion 324 of the evaporator 216 and heat exchange occurs with the refrigerant, moisture included in the air cools and condenses. The condensed moisture (condensed water) adheres to the evaporator 216 and falls downward (direction of arrow B2) due to the weight thereof. The moisture is pressed and moves to the front end of the evaporator 216 due to the air passing through the first heat exchange portion 324 and moves downward (direction of arrow B2) along the front end.

After the moisture moves to the lower end of the evaporator 216, this moisture falls to the drain portion 240 below due to the weight thereof. The moisture moves downward along the bottom surface of the drain portion 240 and is discharged to the exterior of the air conditioning case 212 from the drain port 244.

When the moisture falls from the evaporator 216 to the drain portion 240, the moisture may be dispersed to the rear (direction of arrow A2) due to the air that has passed through the evaporator 216 (cool air). At this time, the longitudinal dimension C (see FIG. 7) of the drain portion 240 in the longitudinal direction (direction of arrows A1 and A2) can be sufficiently secured from the front wall 320 of the lower case 226 to the bottom of the second air intake 272 (direction of arrow B2) toward the rear. Therefore, even when moisture is dispersed from the lower end of the front passage 322 toward the lower passage 304, the moisture can reliably be dropped in the drain portion 240. Thus, moisture dispersed by the cool air can be prevented from reaching the lower passage 304.

Next, a description will be given when a foot mode (warming operation) is selected for blowing warm air to the vicinity of the feet of an occupant in the vehicle interior with reference to FIG. 10 and FIG. 11.

The actuator 298 is driven based on a control signal from a controller not illustrated in the drawings. The door shaft 334 of the switching door 220 rotates clockwise in accordance with the driving of the actuator 298. The shielding portion 336 moves toward the evaporator 216 due to the rotation of the switching door 220. Thus, the introduction passage 276 and the heater core 218 communicate. The communication between the introduction passage 276 and the evaporator 216 is blocked by the shielding portion 336 of the switching door 220.

The foot damper 246 is rotated by a driving device not illustrated in the drawings to open the foot duct 242. At this time, the face duct 280 and the defroster duct 282 are closed.

The fan 314 of the blower 214 is rotationally driven and air from the exterior of the air conditioning case 212 is taken into the interior. Air flows along the blowing passage 256 and is supplied to the introduction passage 276 of the air conditioning case 212. Air flows from the introduction passage 276 toward the heater core 218 and passes through the second heat exchange portion 330 of the heater core 218. At this time, a heat exchange occurs between the warm water circulating in the second heat exchange portion 330 and the air passing through the second heat exchange portion 330. The air is heated due to the heat of the warm water and becomes warm air. The warm air flows to the rear passage 328 downstream from the heater core 218.

The warm air branches in the vertical direction along the rear passage 328 in the rear passage 328. A portion of the warm air on the upper side flowing upward (direction of arrow B1) flows from the rear passage 328 to the upper passage 332. The warm air on the upper side flows along the upper passage 332 toward the front (direction of arrow A1). After warm air on the upper side flows to the front passage 322, the warm air flows downward (direction of arrow B2) along the front passage 322. After warm air on the upper side flows from the lower end of the front passage 322 to the rear (direction of arrow A2) along the lower passage 304, the warm air is supplied to the foot duct 242.

A portion of the warm air on the lower side flowing downward (direction of arrow B2) along the rear passage 328 is supplied to the foot duct 242 along the rear passage 328. The warm air on the upper side and the warm air on the lower side are supplied to the foot duct 242 via respectively different paths. The warm air on the upper side and the warm air on the lower side join each other at the foot duct 242 and are blown from the foot duct 242 to the vicinity of the feet of an occupant in the vehicle interior as warm air. That is, the warm air flows toward the foot duct 242 from the two directions on the upper side and the lower side going around the evaporator 216, the introduction passage 276, and the heater core 218.

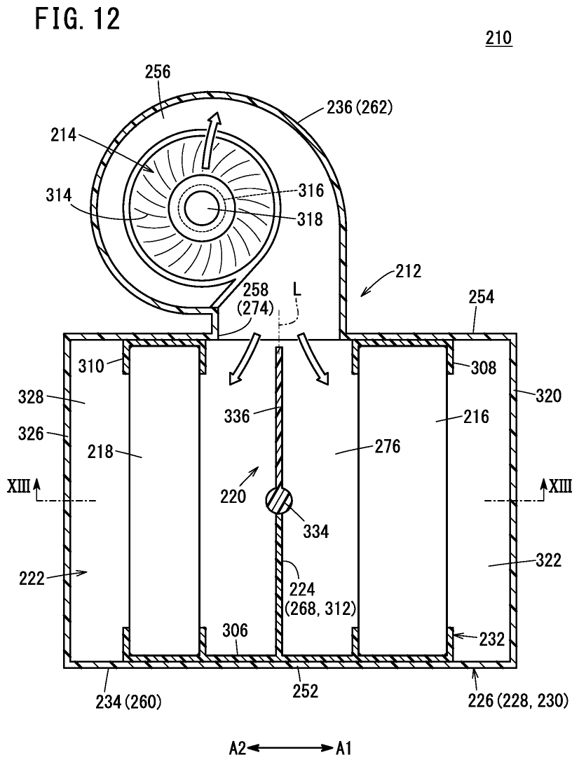

Next, a description will be given when a defroster mode is selected for blowing to the vicinity of the front window in the vehicle interior with reference to FIG. 12 and FIG. 13.

The actuator 298 is driven based on a control signal from a controller not illustrated in the drawings. The switching door 220 is rotated in accordance with the driving of the actuator 298 and the shielding portion 336 is made to be at an intermediate position along the virtual line L. The shielding portion 336 extends along the width direction of the air conditioning case 212. Thus, each of the evaporator 216 and the heater core 218 communicate with the introduction passage 276.

The defroster damper 292 is rotated by a driving device not illustrated in the drawings to open the defroster duct 282. At this time, the face duct 280 and the foot duct 242 are closed.

The fan 314 of the blower 214 is rotationally driven to supply air from the exterior of the air conditioning case 212 into the interior of the introduction passage 276 via the blowing passage 256 and the air intake 274. In the introduction passage 276, air branches in the longitudinal direction (direction of arrows A1 and A2) by the shielding portion 336 of the switching door 220. Half of the air flows toward the evaporator 216 via the front of the shielding portion 336. After being cooled by passing through the first heat exchange portion 324 of the evaporator 216, the cool air flows toward the defroster duct 282 along the front passage 322.

The remaining half of the air supplied to the introduction passage 276 passes the rear of the shielding portion 336 toward the heater core 218. After the remaining half of the air is heated by passing through the second heat exchange portion 330 of the heater core 218, warm air flows to the rear passage 328. The warm air branches in the vertical direction along the rear passage 328 in the rear passage 328.

After a portion of the warm air on the upper side flowing upward (direction of arrow B1) flows upward along the rear passage 328, this air flows to the upper passage 332. The warm air on the upper side flows along the upper passage 332 toward the front (direction of arrow A1). After warm air on the upper side flows to the front passage 322, the warm air is supplied to the defroster duct 282.

After a portion of the warm air on the lower side flowing downward (direction of arrow B2) along the rear passage 328 flows to the lower end of the rear passage 328, this air flows toward to front along the lower passage 304. The warm air on the lower side flows from the lower passage 304 upward (direction of arrow B1) along the front passage 322 and is supplied to the defroster duct 282 along with the cool air. The warm air on the upper side and the warm air on the lower side are supplied to the defroster duct 282 via respectively different paths. Cool air joins with the warm air on the upper side and the warm air on the lower side at the defroster duct 282 and these are blown from the defroster duct 282 to the vicinity of the front window in the vehicle interior. Thus, fogging that occurs on the internal surface of the front window can be suitably removed by the blowing air.

In the front passage 322, the warm air on the lower side heated by passing through the heater core 218 and the cool air dehumidified by passing through the evaporator 216 are mixed at a prescribed ratio. Therefore, air blown to the defroster duct 282 is heated to a prescribed temperature and is dehumidified. Thus, warm air (air) blown from the defroster duct 282 can suitably remove fogging on the front window.

In the front passage 322, the mixing ratio of cool air and warm air on the lower side can be controlled to control the temperature and humidity of the warm air blown from the defroster duct 282.

The minimum passage cross-sectional area in the lower passage 304 in which the lower side warm air flows is smaller than the minimum passage cross-sectional area in the upper passage 332 in which the upper side warm air flows. Therefore, the flow amount of the warm air on the lower side can be smaller than the flow amount of the warm air on the upper side. Thus, narrowing the flow amount of the warm air on the lower side mixed with the cool air more than the flow amount of the warm air on the upper side makes it possible to increase flow amount of the warm air on the upper side and decrease humidity while maintaining blowing temperature.

Lastly, a description will be given when a bi-level mode is selected for blowing cool air to the vicinity of the face of an occupant in the vehicle interior while simultaneously blowing warm air to the vicinity of the feet of the occupant.

The actuator 298 is driven by the control signal from a controller not illustrated in the drawings, the shielding portion 336 of the switching door 220 is made to be at an intermediate position on the switching door 220 along the virtual line L. The face damper 286 and the foot damper 246 are respectively rotated by a driving device not illustrated in the drawings. The face duct 280 and the foot duct 242 are opened. At this time, the defroster duct 282 is closed.

The blower 214 is rotated to supply air from the exterior of the air conditioning case 212 into the interior of the introduction passage 276 via the blowing passage 256 and the air intake 274. In the introduction passage 276, air branches in the longitudinal direction by the shielding portion 336 of the switching door 220. Half of the air flows toward the evaporator 216 via the front of the shielding portion 336. After being cooled by passing through the first heat exchange portion 324 of the evaporator 216, the cool air flows to the front passage 322.

This cool air branches in the vertical direction in the front passage 322. A portion of the cool air on the upper side flowing upward (direction of arrow B1) flows downward from the upper end of the front passage 322 along the upper passage 332. The cool air on the upper side is supplied from the rear of the upper passage 332 to the face duct 280.

A portion of the cool air on the lower side flowing downward (direction of arrow B2) along the front passage 322 flows from the lower end of the front passage 322 toward the rear (direction of arrow A2) along the lower passage 304. The cool air on the lower side is supplied from the rear of the lower passage 304 to the foot duct 242.

Meanwhile, the remaining half of the air supplied to the introduction passage 276 passes the rear (direction of arrow A2) of the shielding portion 336 toward the heater core 218. After being heated by passing through the second heat exchange portion 330 of the heater core 218, this air flows to the rear passage 328 as warm air. The warm air branches in the vertical direction in the rear passage 328.

A portion of the warm air on the upper side flowing upward (direction of arrow B1) flows upward along the rear passage 328 and is supplied to the face duct 280. In the face duct 280, the warm air on the upper side and the cool air on the upper side are mixed. At this time, the supply amount of the warm air on the upper side is less than the supply amount of the cool air on the upper side. Therefore, blown air mixed in the face duct 280 is blown to the vicinity of the face of an occupant in the vehicle interior as cool air that is relatively cool.

A portion of the warm air on the lower side flowing downward (direction of arrow B2) along the rear passage 328 flows along the rear passage 328 and is supplied to the foot duct 242. In the foot duct 242, the warm air on the lower side and the cool air on the lower side are mixed. At this time, the supply amount of the cool air on the lower side is less than the supply amount of the warm air on the lower side. The minimum passage cross-sectional area of the upper passage 332 is larger than the minimum passage cross-sectional area of the lower passage 304. Therefore, the flow amount of cool air on the upper side flowing to the face duct 280 through the upper passage 332 is larger than the flow amount of the cool air on the lower side flowing to the foot duct 242 through the lower passage 304.

Therefore, blown air mixed in the foot duct 242 is blown to the vicinity of the feet of an occupant in the vehicle interior as warm air that is relatively warm. That is, the warm air flows toward the foot duct 242 from the two directions on the upper side and the lower side going around the evaporator 216, the introduction passage 276, and the heater core 218.

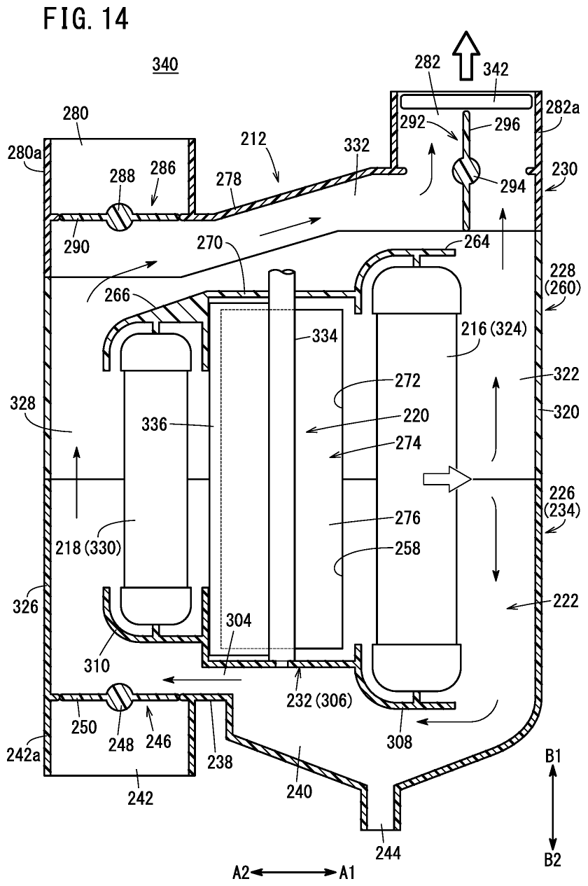

For example, a vehicle air conditioning device 340 according to the first variation illustrated in FIG. 14 may be adopted.

The vehicle air conditioning device 340 is provided with a heater (heating device) 342 as illustrated in FIG. 14. The heater 342 is disposed in the interior of the defroster duct 282. The heater 342 is heated by being energized. The heater 342, for example, is a thermoelectric device such as a positive temperature coefficient (PTC) heater. The heater 342 is disposed to be substantially orthogonal to the opening direction of the defroster duct 282.

When the defroster mode is selected in the vehicle air conditioning device 340, the heater 342 is energized to heat the heater 342. The defroster damper 292 is rotated by a control signal from a controller not illustrated in the drawings to open the defroster duct 282. The switching door 220 is rotated and the introduction passage 276 and the evaporator 216 are made to communicate.

Air is supplied from the blower 214 to the introduction passage 276, and air is cooled and dehumidified by passing through the first heat exchange portion 324 of the evaporator 216 and becomes cool air. After the cool air flows to the front passage 322 of the air conditioning case 212, it is supplied to the opened defroster duct 282.

When the cool air passes through the defroster duct 282, the cool air is heated by the heater 342 and becomes warm air of a prescribed temperature. This warm air is achieved by heating cool air that has been dehumidified in advance. That is, the humidity of air is lower than when air in the air conditioning case 212 is taken in and heated in the heater core 218.

Warm air heated by the heater 342 is blown from the defroster duct 282 to the vicinity of the front window in the vehicle interior. Thus, fogging that occurs on the internal surface of the front window can be suitably removed by the warm air that has been dehumidified.

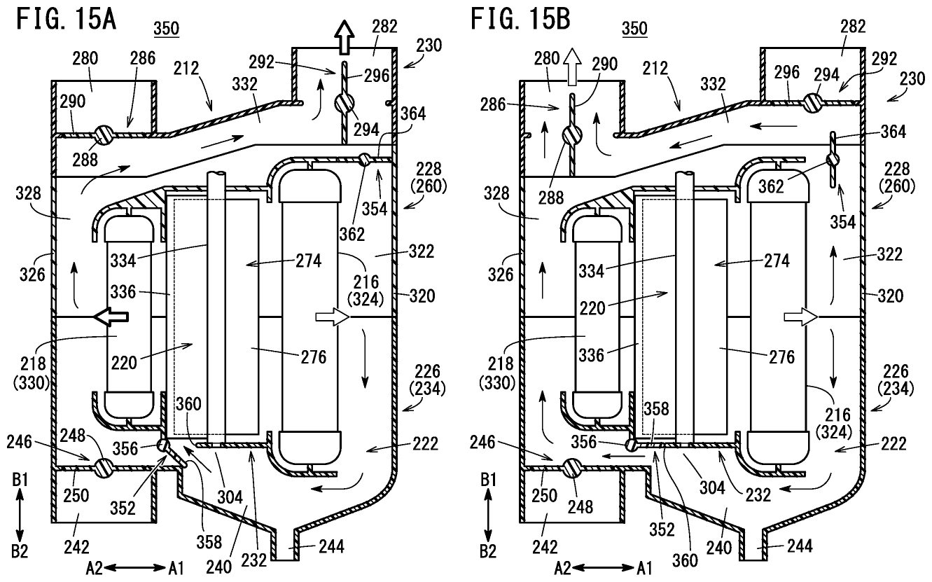

For example, a vehicle air conditioning device 350 according to the second variation illustrated in FIG. 15A and FIG. 15B may be adopted.

This vehicle air conditioning device 350 is provided with a first sub-damper 352 and a second sub-damper 354. The first sub-damper 352 is disposed on the holder main body 306 of the inner holder 232 in the interior of the air conditioning case 212. The first sub-damper 352 is disposed further to the rear (direction of arrow A2) than the lower partition piece 312 in the holder main body 306.

The first sub-damper 352 extends along the width direction orthogonal to the longitudinal direction of the inner holder 232. The first sub-damper 352 is provided with a first damper shaft 356 and a first door portion 358. The first sub-damper 352 is a cantilever system having the first damper shaft 356 and the first door portion 358.

The first damper shaft 356 is rotatably supported on the rear end of the holder main body 306. The first damper shaft 356 extends along the width direction of the inner holder 232. The first door portion 358 is disposed further to the front (direction of arrow A1) than the first damper shaft 356. The first door portion 358 is plate-shaped. The first door portion 358 can open and close the communication hole 360 opened on the holder main body 306. The communication hole 360 penetrates the holder main body 306 in the vertical direction (direction of arrows B1 and B2). The communication hole 360 makes the introduction passage 276 and the lower passage 304 communicate.

The first door portion 358 rotates around the first damper shaft 356 in accordance with the driving of a driving device not illustrated in the drawings. By rotating the first door portion 358 toward the holder main body 306, the communication hole 360 is closed by the first door portion 358.

By rotating the first door portion 358 in the direction separating from the holder main body 306, the first door portion 358 separates from the communication hole 360 and the communication hole 360 is opened. By the first door portion 358 rotating in the direction separating from the holder main body 306, communication of the lower passage 304 is blocked by the first door portion 358.

The second sub-damper 354 is disposed on the front passage 322 of the intermediate case 228 in the interior of the air conditioning case 212. The second sub-damper 354 is disposed at the same height as the first upper holding portion 264 in the front passage 322. The second sub-damper 354 faces the defroster duct 282 and the defroster damper 292. The second sub-damper 354 extends along the width direction orthogonal to the longitudinal direction of the intermediate case 228. The second sub-damper 354 is provided with a second damper shaft 362 and a pair of second door portions 364. The second sub-damper 354 is a butterfly-type door having the second damper shaft 362 and the second door portions 364.

The second damper shaft 362 is rotatably supported substantially in the center of the front passage 322 in the longitudinal direction. The second damper shaft 362 extends along the width direction of the intermediate case 228. The second door portions 364 respectively extend outward in the radial direction from the circumferential surface of the second damper shaft 362. The second door portions 364 are plate-shaped. The second door portions 364 can open and close the upper end of the front passage 322. The second door portions 364 can switch communication between the front passage 322 and the upper passage 332.

The second door portions 364 rotate around the second damper shaft 362 in accordance with the driving of a driving device not illustrated in the drawings. By the pair of second door portions 364 being disposed along the longitudinal direction (direction of arrows A1 and A2), the upper end of the front passage 322 is closed (see FIG. 15A). Communication between the front passage 322, the upper passage 332, and the defroster duct 282 is blocked.

Because second door portions 364 rotate and the pair of second door portions 364 are disposed along the vertical direction (direction of arrows B1 and B2), the upper end of the front passage 322 is opened (see FIG. 15B). The front passage 322, the upper passage 332, and the defroster duct 282 communicate.

When the defroster mode of the vehicle air conditioning device 350 illustrated in FIG. 15A is selected, the first sub-damper 352 is rotated to open the communication hole 360. The second sub-damper 354 is rotated to close the upper end of the front passage 322. The switching door 220 is rotated counter-clockwise and the introduction passage 276 and the evaporator 216 are made to communicate by the switching door 220. Air is supplied from the blower 214 to the introduction passage 276, and this air is cooled by passing through the first heat exchange portion 324 of the evaporator 216 and becomes cool air.

After the cool air flows downward (direction of arrow B2) via the front passage 322, the cool air flows to the rear (direction of arrow A2) along the lower passage 304. The upward (direction of arrow B1) flow of cool air to the defroster duct 282 is blocked by the second sub-damper 354.

After the cool air flows along the lower passage 304, it is guided upward by the first door portion 358 of the first sub-damper 352. The cool air is supplied into the interior of the introduction passage 276 via the opened communication hole 360. The cool air flows to the rear (direction of arrow A2) of the partition wall 224 in the introduction passage 276. The cool air then flows from the introduction passage 276 to the second heat exchange portion 330 of the heater core 218. The cool air is heated by the warm water circulating in the second heat exchange portion 330 and becomes warm air. The warm air flows from the heater core 218 to the rear passage 328, flows upward (direction of arrow B1) along the rear passage 328, and flows to the upper passage 332.

The warm air flows to the front (direction of arrow A1) along the upper passage 332 and is blown from the defroster duct 282 toward the vicinity of the front window in the vehicle interior.

In the vehicle air conditioning device 350, after the air passes through the evaporator 216 and is dehydrated to become cool air, the air is heated in the heater core 218 and is supplied to the defroster duct 282. Thus, heated warm air having low humidity can be blown from the defroster duct 282 to the vicinity of the front window in the vehicle interior. As a result, fogging of the front window can be quickly removed.

Next, when the face mode of the vehicle air conditioning device 350 illustrated in FIG. 15B is selected, the first sub-damper 352 is rotated to close the communication hole 360. The front passage 322 and the rear passage 328 are made to communicate via the lower passage 304. The second sub-damper 354 is rotated to open the upper end of the front passage 322. The introduction passage 276 and the evaporator 216 communicate by the switching door 220.

Air supplied from the blower 214 to the evaporator 216 flows in the vertical direction (direction of arrows B1 and B2) from the front passage 322 as cool air and flows to the upper passage 332 and the lower passage 304. At this time, the communication hole 360 is closed by the first sub-damper 352. Therefore, cool air flowing in the lower passage 304 does not flow from the communication hole 360 into the introduction passage 276. Because the upper end of the front passage 322 is opened by the second sub-damper 354, cool air flows from the front passage 322 to the upper passage 332.

Cool air flowing to the rear along the lower passage 304 and the upper passage 332 is blown from the face duct 280 to the vicinity of the face of an occupant in the vehicle interior via the rear passage 328.

In the vehicle air conditioning device 350 described above, when performing blowing in a blowing mode other than the defroster mode, the communication hole 360 is closed by the first sub-damper 352 and the upper end of the front passage 322 is opened by the second sub-damper 354.

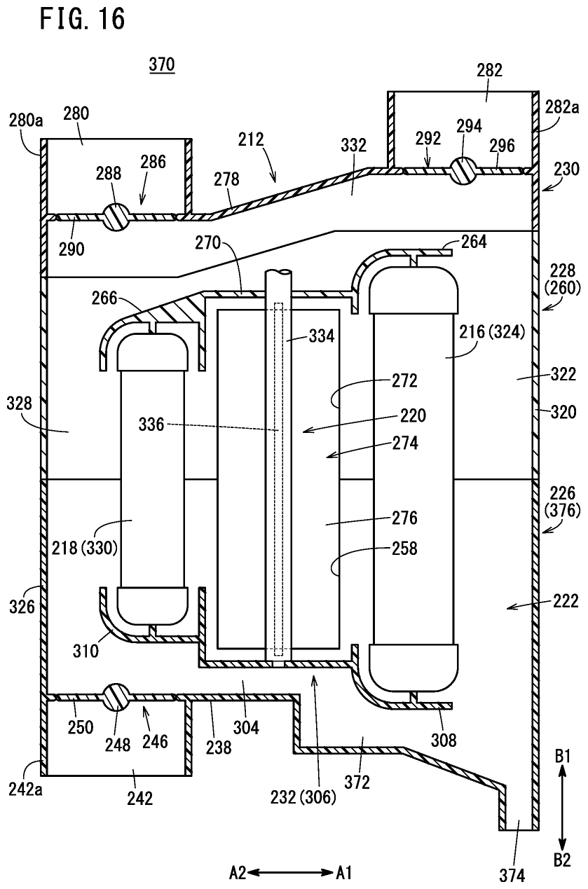

For example, a vehicle air conditioning device 370 according to the third variation illustrated in FIG. 16 may be adopted.

The vehicle air conditioning device 370 is provided with a drain portion 372 and a drain port 374. The drain portion 372 is disposed on the lower end of the first case main body 376. The drain portion 372 is disposed in the front (direction of arrow A1) of the bottom wall 238. The bottom surface of the drain portion 372 slopes downward (direction of arrow B2) towards the front. The bottom surface of the drain portion 372 has the front end disposed the lowest. The drain port 374 is disposed on the front end of the drain portion 372. The drain port 374 has a cylindrical shape. The drain port 374 projects downward (direction of arrow B2) from the lower end of the drain portion 372. The drain port 374 communicates with the interior of the drain portion 372. The drain port 374 communicates with the exterior of the first case main body 376.

Thus, condensed water that has accumulated in the interior of the drain portion 372 is discharged to the exterior of the first case main body 376 (lower case 226) via the drain port 374.

In the third embodiment of the present invention, the evaporator 216 and the heater core 218 are disposed in parallel facing each other in the interior of the air conditioning case 212. The passage 222 of the air conditioning case 212 is provided with the front passage 322, the rear passage 328, the upper passage 332, the lower passage 304, and the introduction passage 276. The evaporator 216 is disposed in the front passage 322. The heater core 218 is disposed in the rear passage 328.

The upper passage 332 connects the front passage 322 and the rear passage 328. The upper passage 332 circumvents the evaporator 216 and the heater core 218 from above (direction of arrow B1). The lower passage 304 connects the front passage 322 and the rear passage 328. The lower passage 304 circumvents the evaporator 216 and the heater core 218 from below (direction of arrow B2). The introduction passage 276 is disposed between the front passage 322 and the rear passage 328. The air from the blower 214 is introduced into the introduction passage 276. The introduction passage 276 is provided with a switching door 220. The switching door 220 branches air in the introduction passage 276 to the front passage 322 and the rear passage 328. The switching door 220 controls the flow amount of the air flowing to the front passage 322 and the rear passage 328.

The air conditioning case 212 includes the face duct 280, the foot duct 242, and the defroster duct 282. The face duct 280 blows air to the vicinity of the face of an occupant in the vehicle interior. The foot duct 242 blows air to the vicinity of the feet of an occupant in the vehicle interior. The defroster duct 282 blows air to the vicinity of the front window in the vehicle interior. The face duct 280 and the defroster duct 282 are disposed facing the upper passage 332. The foot duct 242 is disposed facing the lower passage 304. The minimum passage cross-sectional area of the lower passage 304 is smaller than the minimum passage cross-sectional area of the upper passage 332.

Thus, by disposing the evaporator 216 and the heater core 218 in parallel and disposing the switching door 220 on the introduction passage 276 between the evaporator 216 and the heater core 218, air introduced into the introduction passage 276 can be selectively blown to the front passage 322 or the rear passage 328 by switching the switching door 220. As a result, air does not pass through the evaporator 216 when in the foot mode that does not require heat exchange of the air by the evaporator 216. Therefore, ventilation resistance of air in the foot mode can be reduced.

Therefore, ventilation resistance of air when air flows through the passage 222 of the air conditioning case 212 can be reduced to realize improvements in blowing efficiency.

Cool air that has undergone a heat exchange in the evaporator 216 flows from the front passage 322 to the upper passage 332 and the lower passage 304 and is supplied to the opened face duct 280. Warm air that has undergone a heat exchange in the heater core 218 flows from the rear passage 328 to the upper passage 332 and the lower passage 304 and is supplied to the opened foot duct 242 and defroster duct 282. Making the minimum passage cross-sectional area of the lower passage 304 smaller than the minimum passage cross-sectional area of the upper passage 332, the flow amount of air flowing in the lower passage 304 can be made smaller than the flow amount of air flowing in the upper passage 332.

As a result, the blowing temperature of air blown from the face duct 280, the foot duct 242, and the defroster duct 282 can be suitably controlled by the size of the opening of the switching door 220, and the minimum passage cross-sectional area of the upper passage 332 and the lower passage 304. Therefore, the temperature difference between cool air and warm air can be made larger in the bi-level mode for blowing cool air and warm air from the face duct 280 and the foot duct 242 simultaneously, and the foot and defroster modes for blowing from the foot duct 242 and the defroster duct 282 simultaneously. Thus, the comfort of the occupant in the vehicle interior can be improved.

A large amount of air can be blown from the face duct 280 or the defroster duct 282 via the upper passage 332.

The upper passage 332 communicates with the front passage 322 and the rear passage 328, and the upper passage 332 controls the temperature of air flowing to the face duct 280 and the defroster duct 282. The lower passage 304 communicates with the front passage 322 and the rear passage 328, and the lower passage 304 controls the temperature of air supplied to the foot duct 242.

In the face mode, after cool air has flowed from the evaporator 216 to the front passage 322, cool air flows to the rear along the upper passage 332 and the lower passage 304 and can be supplied to the face duct 280. In the defroster mode, after warm air has flowed from the heater core 218 to the rear passage 328, warm air flows to the front along the upper passage 332 and the lower passage 304 and can be supplied to the defroster duct 282. In this manner, in the upper passage 332 and the lower passage 304, cool air and warm air can flow in two different directions along the longitudinal direction.

As a result, the air conditioning case 212 can be made smaller compared to when a cool air flow path in which cool air flows in the longitudinal direction and a warm air flow path in which warm air flows in the longitudinal direction are provided separately. In the defroster mode, the warm air supplied to the front passage 322 via the lower passage 304 and the cool air supplied to the front passage 322 can be suitably mixed. Thus, warm air and cool air can be mixed at a desired flow amount and blown from the defroster duct 282. As a result, the blowing temperature from the defroster duct 282 can be controlled with higher precision.

The air conditioning case 212 is provided with the lower case 226, the intermediate case 228, and the upper case 230 that can be split in the vertical direction (direction of arrows B1 and B2). The upper case 230 is disposed on the top (direction of arrow B1). The actuator 298 drives the switching door 220. The actuator 298 is fixed to an attachment boss 300 of the upper case 230. Thus, when assembling the air conditioning case 212, the lower case 226, the intermediate case 228, and the upper case 230 can be easily assembled from one direction (vertical direction). Thus, the man-hours required to assemble the air conditioning case 212 can be reduced. The assembly cost of the air conditioning case 212 can be reduced. By disposing the actuator 298 above the air conditioning case 212, the infiltration of moisture or the entry of dust into the actuator 298 from below can be suitably prevented when the vehicle air conditioning device 210 is mounted in a vehicle.

The heater 342 for heating air passing through the defroster duct 282 is provided in the vicinity of the defroster duct 282. Thus, when dehumidified cool air is blown from the defroster duct 282, the cold air is heated by the heater 342 and blown toward the vicinity of the front window as warm air. As a result, fogging of the front window can be reliably removed by warm air having low humidity and high blowing temperature.

The first sub-damper 352 for switching the communication state between the lower passage 304 and the heater core 218, and the second sub-damper 354 for switching the communication state between the evaporator 216 and the defroster duct 282 are provided. In the defroster mode for blowing air from the defroster duct 282 into the vehicle interior, communication between the evaporator 216 and the defroster duct 282 is blocked by the second sub-damper 354, and the lower passage 304 and the heater core 218 are made to communicate by the first sub-damper 352.

Thus, in the defroster mode, dehumidified air that has been cooled by the evaporator 216 (cool air) can be supplied toward the heater core 218 opened by the first sub-damper 352 and heated. As a result, the dehumidified cool air that has been heated and becomes warm air can be blown from the defroster duct 282 to the vicinity of the front window in the vehicle interior. As a result, fogging of the front window can be reliably and quickly removed by warm air having low humidity and high blowing temperature.

The air conditioning case 212 is provided with the drain portion 240 and the drain port 244. The drain portion 240 is disposed below the evaporator 216. The drain portion 240 and the drain port 244 can discharge condensed water occurring in the evaporator 216 to the exterior. The drain portion 240 faces the lower passage 304 of the air conditioning case 212 and is disposed at a position along the extending direction of the lower passage 304.

Because the drain portion 240 has a prescribed length in the longitudinal direction of the air conditioning case 212, the speed of the cool air can be reduced when condensed water is dispersed by the cool air flowing toward the rear below the evaporator 216. Thus, the condensed water is prevented from falling into the drain portion 240 and reaching the lower passage 304. Thus, the condensed water is prevented from infiltrating into the vehicle interior from the foot duct 242 or the face duct 280 via the lower passage 304. Furthermore, by disposing the drain portion 240 at any position along the extending direction of the lower passage 304, interference with other adjacent components in the vehicle can be suitably avoided.

The air conditioning case 212 is not limited to being provided with the face duct 280, the defroster duct 282, and the foot duct 242.

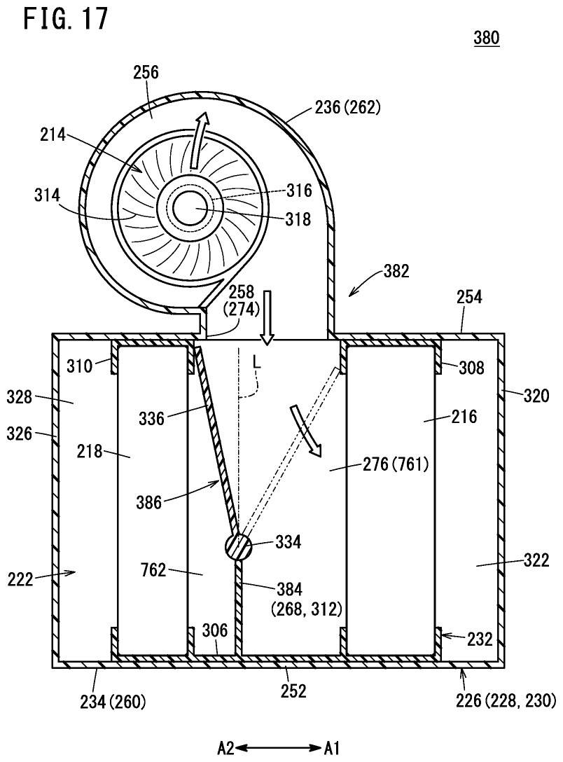

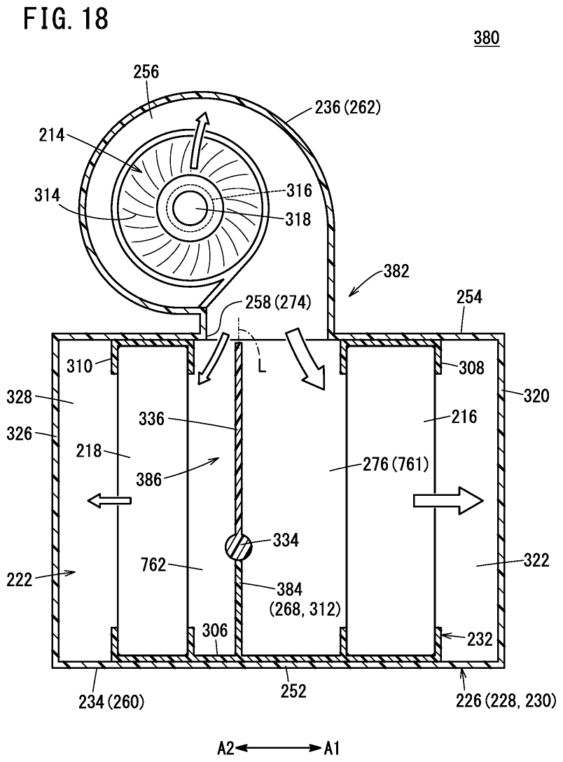

Next, a vehicle air conditioning device 380 according to the fourth embodiment will be described with reference to FIG. 17 and FIG. 18. Note that the same reference numerals are given to constituent elements that are the same as those in the vehicle air conditioning device 210 according to the third embodiment described above, and detailed descriptions thereof will be omitted.

The vehicle air conditioning device 380 is provided with an air conditioning case 382 The interior of the air conditioning case 382 is provided with a partition wall 384 and a switching door 386.

The partition wall 384 is disposed on a position adjacent to the heater core 218 from the center of the air conditioning case 212 in the longitudinal direction. In other words, the partition wall 384 is disposed offset by a prescribed distance from the center of the introduction passage 276 in the longitudinal direction toward the heater core 218.

The switching door 386 faces an end portion of the partition wall 384. The switching door 386 is disposed adjacent to the heater core 218 from the center of the air conditioning case 212 in the longitudinal direction. Similar to the partition wall 384, the switching door 386 is offset by a prescribed distance from the center of the introduction passage 276 in the longitudinal direction toward the heater core 218.

Thus, the introduction passage 276 is separated into a first space 761 and a second space 762 by the partition wall 384 and the switching door 386. The first space 761 faces the evaporator 216. The second space 762 faces the heater core 218. The length of the first space 761 in the longitudinal direction is longer than the length of the second space 762 in the longitudinal direction. The volume of the first space 761 is larger than the volume of the second space 762. Thus, when air is supplied from the blower 214 to the introduction passage 276 via the air intake 274, the amount of supplied air to the first space 761 is larger than the amount of supplied air to the second space 762 according to the ratio of the length of the first space 761 and the second space 762 in the longitudinal direction.

Next, a description will be given of the operation of the vehicle air conditioning device 380.

First, a description will be given when the face mode (cooling operation) is selected for blowing cool air to the vicinity of the face of an occupant in the vehicle interior with reference to FIG. 17.

In the face mode, the switching door 386 rotates and the shielding portion 336 moves toward the heater core 218. Thus, the first space 761 of the introduction passage 276 and the evaporator 216 communicate. The communication between the second space 762 of the introduction passage 276 and the heater core 218 is blocked by the shielding portion 336 of the switching door 386.

Air is supplied from the blower 214 to the first space 761 of the introduction passage 276 via the air intake 274. Air in the first space 761 flows toward the opened evaporator 216 and is cooled. After cool air flows from the evaporator 216 to the front passage 322, the air is supplied to the vicinity of the face of an occupant in the vehicle interior via the face duct 280.

Because the first space 761 facing the evaporator 216 is larger than the second space 762 facing the heater core 218 at this time, a large amount of air supplied from the blower 214 can be supplied to the evaporator 216. As a result, in the face mode, a large amount of cool air can be blown to the vicinity of the face of an occupant in the vehicle interior.

Next, a description will be given wherein the bi-level mode is selected in the vehicle air conditioning device 380 with reference to FIG. 18.

In the bi-level mode, the shielding portion 336 of the switching door 386 is at an intermediate position (on the virtual line L) extending toward the air intake 274. Thus, the first space 761 and the second space 762 of the introduction passage 276 both communicate with the air intake 274.

Air is supplied from the blower 214 to the introduction passage 276 via the air intake 274, and a portion of the air flows from the first space 761 toward the evaporator 216. A portion of the air flows from the second space 762 toward the heater core 218. At this time, the first space 761 is larger than the second space 762. Thus, the flow amount of cool air that flows to the evaporator 216 and is cooled is larger than the flow amount of warm air that flows to the heater core 218 and is heated. Thus, the amount of cool air blown from the face duct 280 to the vicinity of the face of an occupant in the vehicle interior can be made larger than the amount of warm air blown from the foot duct 242 to the vicinity of the feet of an occupant in the vehicle interior.

In the vehicle air conditioning device 380, the partition wall 384 and the switching door 386 are made to be adjacent to the heater core 218 from the center of the air conditioning case 382 in the longitudinal direction. Thus, in the bi-level mode wherein cool air and warm air are simultaneously blown into the vehicle interior, the flow rate of air flowing from the first space 761 toward the evaporator 216 can be made greater than the flow amount of air flowing from the second space 762 toward the heater core 218.

As a result, the amount of cool air and the amount of warm air blown into the vehicle interior can be controlled. Thus, the amount of cool air blown can be made larger than the amount of warm air blown to perform temperature control with higher precision.

In the face mode, a large amount of cool air can be blown from the face duct 280 into the vehicle interior.

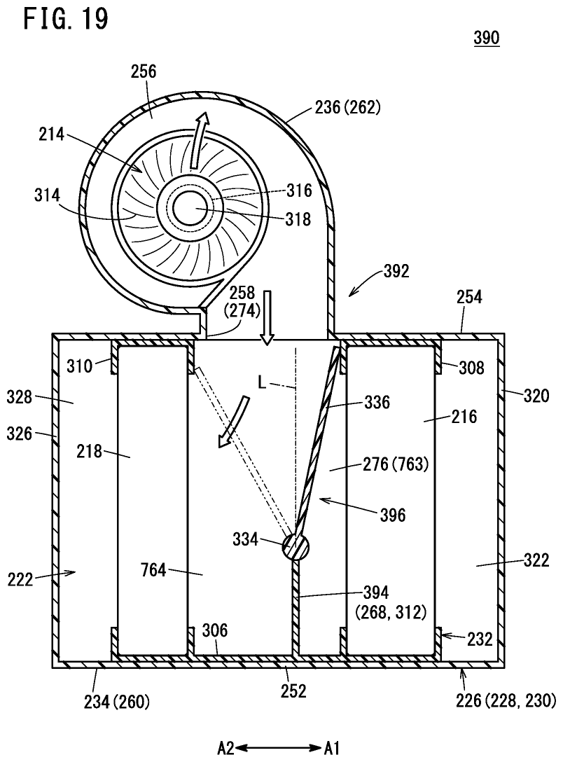

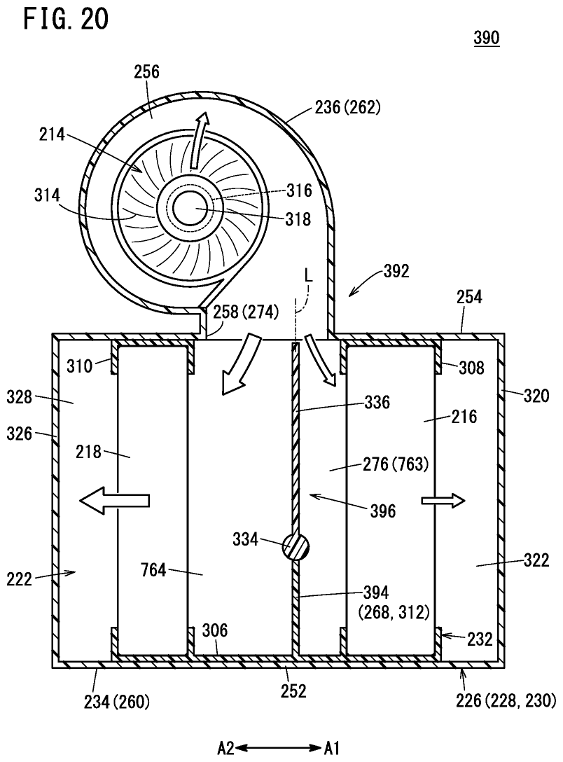

Next, a vehicle air conditioning device 390 according to the fifth embodiment will be described with reference to FIG. 19 and FIG. 20. Note that the same reference numerals are given to constituent elements that are the same as those in the vehicle air conditioning device 210 according to the third embodiment described above, and detailed descriptions thereof will be omitted.

The vehicle air conditioning device 390 is provided with an air conditioning case 392. The interior of the air conditioning case 392 is provided with a partition wall 394 and a switching door 396.

The partition wall 394 is disposed to be adjacent to the evaporator 216 from the center of the air conditioning case 392 in the longitudinal direction. In other words, the partition wall 394 is disposed offset by a prescribed distance from the center of the introduction passage 276 in the longitudinal direction toward the evaporator 216.

The switching door 396 faces an end portion of the partition wall 394. The switching door 396 is disposed adjacent to the evaporator 216 from the center of the air conditioning case 392 in the longitudinal direction. Similar to the partition wall 394, the switching door 396 is offset by a prescribed distance from the center of the introduction passage 276 in the longitudinal direction toward the evaporator 216.

Thus, the introduction passage 276 is separated into a first space 763 and a second space 764 by the partition wall 394 and the switching door 396. The first space 763 faces the evaporator 216. The second space 764 faces the heater core 218. The length of the first space 763 in the longitudinal direction is shorter than the length of the second space 764 in the longitudinal direction. The volume of the first space 763 is smaller than the volume of the second space 764. Thus, when air is supplied from the blower 214 to the introduction passage 276 via the air intake 274, the amount of supplied air to the first space 763 is less than the amount of supplied air to the second space 764 according to the ratio of the length of the first space 763 and the second space 764 in the longitudinal direction.

Next, a description will be given of the operation of the vehicle air conditioning device 390.

First, a description will be given when the foot mode (warming operation) is selected for blowing warm air to the vicinity of the feet of an occupant in the vehicle interior with reference to FIG. 19.

In the foot mode, the switching door 396 rotates and the shielding portion 336 moves toward the evaporator 216. Thus, the second space 764 of the introduction passage 276 and the heater core 218 communicate. The communication between the introduction passage 276 and the evaporator 216 is blocked by the shielding portion 336 of the switching door 396.

Air is supplied from the blower 214 to the second space 764 of the introduction passage 276 via the air intake 274. Air in the second space 764 flows toward the opened heater core 218 and is heated. After warm air flows from the heater core 218 to the rear passage 328, the air is supplied to the vicinity of the feet of an occupant in the vehicle interior via the foot duct 242. At this time, the second space 764 facing the heater core 218 is larger than the first space 763 facing the evaporator 216.

Thus, a large amount of air supplied from the blower 214 can be supplied to the heater core 218. As a result, in the foot mode, a large amount of warm air can be blown to the vicinity of the feet of an occupant in the vehicle interior.

Next, a description will be given wherein the bi-level mode is selected in the vehicle air conditioning device 390 with reference to FIG. 20.

In the bi-level mode, the shielding portion 336 of the switching door 396 is at an intermediate position (on the virtual line L) extending toward the air intake 274. Thus, the first space 763 and the second space 764 of the introduction passage 276 both communicate with the air intake 274.

Air is supplied from the blower 214 to the introduction passage 276 via the air intake 274, and a portion of the air flows from the first space 763 toward the evaporator 216. A portion of the air flows from the second space 764 toward the heater core 218. At this time, the second space 764 is larger than the first space 763.

Thus, the flow amount of warm air that flows to the heater core 218 and is heated is larger than the flow amount of cool air that flows to the evaporator 216 and is cooled. Thus, the amount of warm air blown from the foot duct 242 to the vicinity of the feet of an occupant in the vehicle interior can be made larger than the amount of cool air blown from the face duct 280 to the vicinity of the face of an occupant in the vehicle interior.

In the vehicle air conditioning device 390, the partition wall 394 and the switching door 396 are made to be adjacent to the evaporator 216 from the center of the air conditioning case 392 in the longitudinal direction. Thus, in the bi-level mode wherein cool air and warm air are simultaneously blown into the vehicle interior, the flow amount of air flowing from the second space 764 toward the heater core 218 can be made greater than the flow amount of air flowing from the first space 763 toward the evaporator 216.

As a result, the amount of cool air and the amount of warm air blown into the vehicle interior can be controlled. Thus, the amount of warm air blown can be made larger than the amount of cool air blown to perform temperature control in the vehicle interior with higher precision.

In the foot mode, a large amount of warm air can be blown from the foot duct 242 to the vicinity of the feet of an occupant in the vehicle interior.

Note that the present invention is not limited to the embodiments described above and can have various configurations without deviating from the main points of the present invention.

1. A vehicle air conditioning device, comprising:
an air conditioning case having a passage in which air flows;
a blower connected to the air conditioning case for blowing the air;
a cooler and a heater housed in an interior of the air conditioning case;
a duct provided in the air conditioning case for conveying the air that has been temperature controlled by the cooler and the heater;
the passage in the air conditioning case including a cool air passage in which the cooler is disposed, a warm air passage in which the heater is disposed and an introduction passage provided between the cool air passage and the warm air passage for communicating upstream from the cool air passage and the warm air passage, to which air is introduced from the blower; and
wherein air in the introduction passage branches to the cool air passage and the warm air passage, and a switching door is provided in the introduction passage for controlling an amount of the air flowing to the cool air passage and the warm air passage.

2. The vehicle air conditioning device according to claim 1, wherein:
the cooler includes a first heat exchange portion through which the air passes and in which heat exchange is performed with a first heat exchange medium,
the heater includes a second heat exchange portion through which the air passes and in which heat exchange is performed with a second heat exchange medium, and
the first heat exchange portion and the second heat exchange portion are disposed to face each other with interposing a partition plate separating the cool air passage and the warm air passage.

3. The vehicle air conditioning device according to claim 2, wherein:
the switching door is a plate door that includes a rotating shaft supported by the air conditioning case and a shielding plate extending in a direction orthogonal to a shaft direction of the rotating shaft; and
the rotating shaft is disposed between the cooler and the heater.

4. The vehicle air conditioning device according to claim 1, wherein in the air conditioning case, a passage length of the passage from the cooler to the duct is longer than a passage length of the passage from the heater to the duct.

5. The vehicle air conditioning device according to claim 4, wherein
the cooler is disposed further on a lower side in a weight direction than the duct in the air conditioning case.

6. The vehicle air conditioning device according to claim 1, wherein:
the passage of the air conditioning case further includes an upper passage connecting the cool air passage and the warm air passage that circumvents the cooler and the heater from above and a lower passage connecting the cool air passage and the warm air passage that circumvents the cooler and the heater from below;
the duct comprises a first duct disposed facing the upper passage and communicating with the upper passage for blowing air into a vehicle interior and a second duct disposed facing the lower passage and communicating with the lower passage for blowing air into the vehicle interior; and
a minimum passage cross-sectional area of the lower passage is smaller than a minimum passage cross-sectional area of the upper passage.

7. The vehicle air conditioning device according to claim 6, wherein:
the first duct includes a face duct for blowing to the vicinity of a face of an occupant in the vehicle interior and a defroster duct for blowing to the vicinity of a front window in the vehicle interior; and
the upper passage communicates with the cool air passage and the warm air passage and controls the temperature of air flowing to the face duct and the defroster duct, the second duct has a foot duct for blowing to the vicinity of feet of an occupant in the vehicle interior, and the lower passage communicates with the cool air passage and the warm air passage and controls the temperature of air supplied to the foot duct.

8. The vehicle air conditioning device according to claim 6, wherein the air conditioning case includes a split case portion that can be split in a vertical direction, and a driving source for driving the switching door is disposed on an upper portion of a split case portion disposed on an uppermost portion.

9. The vehicle air conditioning device according to claim 7, further comprising a heating device for heating the air passing through the defroster duct is provided in the vicinity of the defroster duct.

10. The vehicle air conditioning device according to claim 7, further comprising:
a first sub-damper for switching a communication state between the lower passage and the heater; and
a second sub-damper for switching a communication state between the cooler and the defroster duct;
wherein in a blowing mode for blowing air from the defroster duct, communication between the cooler and the defroster duct is blocked by the second sub-damper, and the lower passage and the heater are made to communicate by the first sub-damper.

11. The vehicle air conditioning device according to claim 6, wherein:
the air conditioning case includes a drain portion disposed below the cooler for discharging condensed water occurring in the cooler to an exterior; and
the drain portion faces the lower passage and is disposed at a position along an extending direction of the lower passage.

12. The vehicle air conditioning device according to claim 6, wherein the partition plate and the switching door are disposed at a position between the cooler and the heater.

13. A vehicle, comprising: an air conditioning device, the air conditioning device including:
an air conditioning case having a passage in which air flows;
a blower connected to the air conditioning case for blowing the air;
a cooler and a heater housed in an interior of the air conditioning case;
a duct provided in the air conditioning case for conveying the air that has been temperature controlled by the cooler and the heater;
the passage in the air conditioning case including a cool air passage in which the cooler is disposed, a warm air passage in which the heater is disposed, and an introduction passage provided between the cool air passage and the warm air passage for communicating upstream from the cool air passage and the warm air passage, to which air is introduced from the blower; and
wherein air in the introduction passage branches to the cool air passage and the warm air passage, and a switching door is provided in the introduction passage for controlling an amount of the air flowing to the cool air passage and the warm air passage.

14. The vehicle according to claim 13, wherein:
the cooler comprises a first heat exchange portion through which the air passes and in which heat exchange is performed with a first heat exchange medium;
the heater comprises a second heat exchange portion through which the air passes and in which heat exchange is performed with a second heat exchange medium; and
the first heat exchange portion and the second heat exchange portion are disposed to face each other with interposing a partition plate separating the cool air passage and the warm air passage.

15. The vehicle according to claim 14, wherein:
the switching door is a plate door that includes a rotating shaft supported by the air conditioning case, and a shielding plate extending in a direction orthogonal to a shaft direction of the rotating shaft; and
the rotating shaft is disposed between the cooler and the heater.

16. The vehicle according to claim 13, wherein:
the passage of the air conditioning case further includes an upper passage connecting the cool air passage and the warm air passage that circumvents the cooler and the heater from above, and a lower passage connecting the cool air passage and the warm air passage that circumvents the cooler and the heater from below;
the duct includes a first duct disposed facing the upper passage and communicating with the upper passage for blowing air into a vehicle interior, and a second duct disposed facing the lower passage and communicating with the lower passage for blowing air into the vehicle interior; and
a minimum passage cross-sectional area of the lower passage is smaller than a minimum passage cross-sectional area of the upper passage.

17. The vehicle according to claim 16, wherein:
the first duct comprises a face duct for blowing to the vicinity of a face of an occupant in the vehicle interior, and a defroster duct for blowing to the vicinity of a front window in the vehicle interior; and
the upper passage communicates with the cool air passage and the warm air passage and controls the temperature of air flowing to the face duct and the defroster duct, the second duct has a foot duct for blowing to the vicinity of feet of an occupant in the vehicle interior, and the lower passage communicates with the cool air passage and the warm air passage and controls the temperature of air supplied to the foot duct.

18. The vehicle according to claim 17, further comprising a heating device for heating the air passing through the defroster duct provided in the vicinity of the defroster duct.

19. The vehicle according to claim 16, further comprising a first sub-damper for switching a communication state between the lower passage and the heater, and a second sub-damper for switching a communication state between the cooler and the defroster duct; and
wherein in a blowing mode for blowing air from the defroster duct, communication between the cooler and the defroster duct is blocked by the second sub-damper, and the lower passage and the heater are made to communicate by the first sub-damper.

20. The vehicle according to claim 16, wherein:
the air conditioning case includes a drain portion disposed below the cooler for discharging condensed water occurring in the cooler to an exterior; and
the drain portion faces the lower passage and is disposed at a position along an extending direction of the lower passage.
